(19) United States
(12) Patent Application Publication
(10) Pub. No.: US 2012/0317913 A1
(43) Pub. Date: Dec. 20, 2012

(54) Grooved Tiles, Grooved Tile Assemblies and Related Methods

(76) Inventor: Krisann ESQUIVEL, Fresno, CA (US)

(21) Appl. No.: 13/492,431

(22) Filed: Jun. 8, 2012

Related U.S. Application Data
(60) Provisional application No. 61/497,396, filed on Jun. 15, 2011.

(51) Int. Cl. E04F 13/072; E04G 21/14; B26D 3/06; B44F 3/00

(52) U.S. Cl. 52/311.2; 52/316; 52/747.11; 83/875; 409/131

(57) ABSTRACT

Grooved tiles, grooved tile assemblies, methods of manufacturing grooved tiles, and methods of forming grooved tile assemblies are disclosed. The tiles of the present invention include grooves or recesses in the top surface that form one or more complete patterns and/or partial patterns, and that may intersect with one or more edges of the tile. The grooves of one tile can advantageously mate with the grooves of other identical or different grooved tiles when the intersection locations of adjacent tiles are aligned. In addition, the grooved tiles can provide the appearance of including numerous smaller individual tiles, thus eliminating the need for separately placing spacers between the tiles or first backing the tiles with mesh, netting, or paper backing prior to or during installation.

### CROSS REFERENCE TO RELATED APPLICATION

This application claims the benefit of U.S. Provisional Patent Application No. 61/497,396, filed Jun. 15, 2011.

### FIELD OF THE INVENTION

The present invention generally relates to the field of tiles. More specifically, embodiments of the present invention pertain to grooved tiles, grooved tile assemblies, methods of manufacturing grooved tiles and methods of forming grooved tile assemblies.

### DISCUSSION OF THE BACKGROUND

Tiles are used for covering a wide variety of objects and surfaces for indoor and outdoor uses such as floors, walls, showers, pools and surrounding decks, tables, countertops, backsplashes, cabinets, fireplaces and other surfaces or objects. Tiles may be functional (i.e., to protect the surface that is covered) or may be used for strictly decorative purposes, such to create wall, floor, tabletop or ceiling designs or mosaics. Tile materials in various sizes, shapes, and colors may be assembled to create a tile unit or assembly that is not only functional, but decorative as well.

Conventional tiles utilize a variety of different materials suitable for different applications, and are available in numerous sizes, shapes and colors to beautify and/or protect the surface on which the tiles are laid. For example, functional and/or decorative surfaces may be formed using tiles made of cement, concrete, stone (e.g., granite, slate, soapstone, marble, limestone, quartzite, travertine, etc.), leather, wood, cork, metal, glass, ceramics, composites, and porcelain. A multitude of different designs may be created in an assembly of tiles by artfully combining different sizes, shapes, and/or colors of tiles to create patterns which are aesthetically pleasing yet, because of the material from which the tile is made, are functional as well. For example, individual ceramic tiles of different sizes may be laid next to each other so as to create a single unit or assembly. Repeated use of a particular size, shape, and/or color of tile in specified locations and/or orientations throughout the assembly may create patterns that add beauty to a large area such as a floor, ceiling, or countertop. More than one shape, such as octagonal and diamond-shaped tiles, and in different colors, may also be placed relative to each other to create one or more patterns in a tile assembly. In these conventional tile assemblies, care must be taken to place tiles of different shapes, colors, and sizes in appropriate locations to continue the pattern throughout the assembly of tiles. Such careful placement requires additional time and adds to the cost of the tile installation.

Some conventional tiles may also be painted with a distinctive design that is completely contained within the edges of each tile so that these painted tiles may be intermingled or scattered in a predetermined pattern throughout the tile assembly. Again, care must be taken to correctly place the tiles within the assembly to create the desired “look” throughout the assembly. In some instances, scored tiles can be used in a design. However, such tiles typically include only straight score lines that intersect opposing edges of the tile, are generally limited to ceramics, and are usually scored after the ceramic tile has been glazed and/or cut for installation. Furthermore, such conventional scored tiles are usually water jet cut, and in most instances the scored tile must be grouted after the scoring process, for example to ensure that they are sturdy enough to withstand use over time without cracking or breaking the tile.

Some conventional tile assembly designs utilize numerous small tiles laid in patterns to create decorative mosaics. However, use of mosaic tiles (typically tiles smaller than 6 square inches) is labor intensive. To speed the process of creating patterns out of mosaic tiles, the small tiles are often glued or otherwise adhered to a mesh, netting, or paper backing at uniform distances between the tiles so that “sheets” of tiles may be placed at one time, thereby eliminating the need to painstakingly set individual tiles in a uniform manner when the tiles are installed on the object or surface they will cover. However, gluing tiles to mesh, netting, or paper backing requires one or more extra steps in the manufacturing and/or installation processes, thus increasing the cost of the tiles and of creating a design using small tiles. Additionally, creativity may be limited because the small tiles are generally square (in lieu of other cut polygonal or curved shapes), and are placed in predetermined positions on the backing, generally creating a uniform grid of tiles.

Typically, in conventional tile assemblies where larger tiles are used, the tiles are placed individually and spacers are set in between adjacent tiles to keep the distance between the tiles substantially constant and to maintain uniform widths of grout joints. The additional labor cost in setting the spacers may also increase the cost of the tile installation.

Therefore, it is desirable to provide a sturdy tile, wherein the patterns in the tiles easily mate to create a decorative pattern without the need to systematically place the individual tiles within the assembly. It is also desirable to provide a tile that gives the appearance of being formed from a plurality of individual tiles, yet eliminates the cost associated with separately placing small tiles, placing spacers in between the tiles of an assembly, or first backing small tiles with mesh, netting, or paper so that the tiles may be placed in sheets.

### SUMMARY OF THE INVENTION

Embodiments of the present invention relate to grooved tiles, grooved tile assemblies, methods of manufacturing grooved tiles, and methods of forming grooved tile assemblies.

In one embodiment, the invention relates to a grooved tile, comprising (a) a top surface; (b) at least one edge; and (c) one or more grooves or recesses in the top surface, the one or more grooves or recesses configured to form one or more complete patterns and/or one or more partial patterns. In some embodiments, the one or more grooves or recesses do not intersect any edge(s) of the grooved tile. However, the invention is not limited as such and in other embodiments of the grooved tile, at least one of the one or more grooves intersects one or more of the edges of the grooved tile at one or more intersection locations. In further embodiments, at least one of the one or more grooves mates with at least one of the one or more grooves in an adjacent grooved tile with identical intersection locations at at least a subset of the one or more intersection locations when an intersected edge of the grooved tile is placed adjacent to and/or aligned with an intersected edge of the grooved tile with identical intersection locations. In yet other embodiments, the one or more grooves, when grouted, give the appearance that the grooved tile is made up of a plurality of individual tiles. In such embodiments, each of the individual tiles has the shape of the complete pattern, the partial pattern, or the same or a different complete pattern made up of two or more partial patterns.

In some embodiments, the tile is a bisque tile, but a variety of materials may be used as described in detail herein. In some implementations, the shape of the top surface of the grooved tile is a square, but in other embodiments, the top surface may be regular or irregular, and in some instances may have a triangular, rectangular, rhombic, quadrilateral, pentagonal, hexagonal, octagonal, circular, elliptical, oval or other polygonal or curved shape. The grooves in the top surface of the tile may have substantially the same or similar width or, in some embodiments, the grooves may have unequal widths. Furthermore, the cross-sectional shape of the grooves may be triangular, square, conical, tapered, semicircular, rectangular, or other desired shape. In some embodiments, the grooves are narrow in comparison to the average or mean width of the tile. In other embodiments the grooves may be relatively wide compared to the average or mean width of the tiles. In some embodiments, the grooves or recesses do not intersect any edge(s) of the grooved tile. In other embodiments, the grooves or recesses intersect only some of the edges of the grooved tile. In still further embodiments, the grooves intersect all of the edges of the grooved tile.

The invention also relates to a grooved tile assembly, comprising a plurality of grooved tiles, wherein each grooved tile of the assembly comprises (a) a top surface; (b) at least one edge, and (c) one or more grooves or recesses in the top surface. In general, the one or more grooves or recesses are configured to form one or more complete patterns and/or one or more partial patterns in the top surface, and the grooved tiles are arranged in a repeating pattern such that the partial patterns form a larger pattern. In other embodiments, there are no partial patterns in the grooved tiles of the assembly, and the one or more grooves in the top surface of each tile form only one or more complete patterns that are completely within the edge(s) of each grooved tile. In some embodiments, at least one of the one or more grooves of each grooved tile in the assembly intersects at least one edge of the grooved tile at one or more intersection locations, and in some variations, at least one groove in each grooved tile in the assembly mates with one or more grooves in another grooved tile in the assembly at at least a subset of the intersection location(s).

In embodiments of a grooved tile assembly where the grooved tiles include one or more partial pattern(s), when first grooved tiles and second grooved tiles are placed adjacent to each other, the partial pattern(s) of each of the first grooved tiles and the second grooved tiles form a complete pattern, a new pattern, or another partial pattern. In some embodiments, the grooved tiles in an assembly form patterns from grooves that follow straight lines in the top surface of the tile when viewed in plan. In other assemblies, the grooves in the tiles follow conic, cubic, quartic, or other planar curved lines in the top surface, or the grooves may follow a combination of straight and curved lines. In some embodiments, the complete patterns of the first grooved tiles and the second grooved tiles are the same. In other embodiments, the complete patterns of the first grooved tiles and second grooved tiles are different. In some grooved tile assemblies, the patterns formed from the partial patterns have a single axis or plane of symmetry when viewed in plan. In other embodiments, the patterns formed from the partial patterns have multiple axes or planes of symmetry.

The invention further relates to a method of manufacturing a grooved tile. In general, the method comprises (a) securing a tile blank in a groove-forming device, the tile blank having a top surface and at least one edge and (b) forming one or more grooves or recesses in the top surface, wherein the one or more grooves or recesses are configured to form one or more complete patterns and/or one or more partial patterns in the top surface. In some embodiments, there are no partial patterns formed, and the one or more grooves form only complete patterns that are completely within the edge(s) of the grooved tile. In other embodiments, at least one of the one or more grooves intersects at least one edge at one or more intersection locations along each intersected edge. In some embodiments, at least one groove mates at the one or more intersection locations with at least one groove in a grooved tile with identical intersection locations when the intersected edges of the grooved tile and the grooved tile with identical intersection locations are placed next to and/or are aligned with each other. In some embodiments, the grooves are formed by routing the grooves in the tile blank with a router. In other embodiments, the grooves may be scored, etched, or cut using conventional scoring, etching, or cutting equipment and/or methods capable of forming patterned grooves or recesses.

The invention further relates to a method of forming a grooved tile assembly, comprising (a) applying an adhesive on the back surface of the tile and/or on a surface to be covered; (b) arranging the grooved tiles on the surface such that at least one edge of each grooved tile is adjacent to at least one edge of one or more other grooved tiles in the assembly; and (c) placing grout in, between, and/or on top of the grooved tiles; and optionally (d) wiping the surface of the tiles.

Embodiments of the present invention can advantageously provide grooved tiles having grooves that easily mate with the grooves in other identical or different grooved tiles when the intersection locations of adjacent tiles are aligned. Embodiments of the present invention can also advantageously provide tiles that give the appearance of being made of numerous smaller individual tiles, thus eliminating the need for separately placing smaller individual tiles and/or spacers between the tiles, or first backing the tiles with mesh, netting, or paper backing.

### BRIEF DESCRIPTION OF THE DRAWINGS

FIG. 1A is a perspective view of a grooved tile according to a first exemplary embodiment of the present invention.

FIG. 1B is a plan view of the grooved tile of FIG. 1A.

FIG. 1C is a side view of the grooved tile of FIG. 1A.

FIG. 2A is a plan view of an assembly of grooved tiles, utilizing the grooved tile of FIG. 1A.

FIG. 2B is a perspective view of the assembly of grooved tiles of FIG. 2A.

FIG. 3A is a perspective view of a grooved tile according to a second exemplary embodiment of the present invention.

FIG. 3B is a plan view of the grooved tile of FIG. 3A.

FIG. 3C is a side view of the grooved tile of FIG. 3A.

FIG. 4A is a plan view of an assembly of grooved tiles, utilizing the grooved tile of FIG. 3A.

FIG. 4B is a perspective view of the assembly of grooved tiles of FIG. 4A.

FIG. 5A is a plan view of a grooved tile according to a third exemplary embodiment of the present invention.

FIG. 5B is a side view of the grooved tile of FIG. 5A.

FIG. 5C is a plan view of an assembly of grooved tiles, utilizing the grooved tile of FIG. 5A.

FIG. 6A is a plan view of a grooved tile according to a fourth exemplary embodiment of the present invention.

FIG. 6B is a side view of one side of the grooved tile of FIG. 6A.

FIG. 6C is a view of a side opposite the one side of the grooved tile shown in FIG. 6B.

FIG. 6D is a plan view of an assembly of grooved tiles, utilizing the grooved tile of FIG. 6A.

FIG. 7A is a plan view of a grooved tile according to a fifth exemplary embodiment of the present invention.

FIG. 7B is a side view of the grooved tile of FIG. 7A.

FIG. 7C is a plan view of an assembly of grooved tiles, utilizing the grooved tile of FIG. 7A.

FIG. 8A is a plan view of a grooved tile according to a sixth exemplary embodiment of the present invention.

FIG. 8B is a side view of the grooved tile of FIG. 8A.

FIG. 8C is a plan view of an assembly of grooved tiles, utilizing the grooved tile of FIG. 8A.

FIG. 9A is a plan view of an embodiment of a grooved tile showing integral spacers.

FIG. 9B is a side view of the grooved tile of FIG. 9A.

FIG. 10 is a plan view of an assembly of grooved tiles utilizing both the grooved tiles of FIG. 1A and FIG. 3A.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications, and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. In addition, it should be understood that the possible permutations and combinations described herein are not meant to limit the invention. Specifically, variations that are not inconsistent may be mixed and matched as desired.

For the sake of convenience and simplicity, the terms “design,” “pattern,” “shape,” and “configuration” may be used interchangeably herein, but are generally given their art-recognized meanings. Also, for convenience and simplicity, the terms “grooved tile assembly,” “tile assembly,” and “assembly,” may be used interchangeably, and wherever one such term is used, it also encompasses the other terms.

Embodiments of the present invention can advantageously provide a grooved tile wherein the patterns of the grooved tile may be continued or completed, or may form a new pattern when mated with the grooves of an identical grooved tile or a different grooved tile with identical intersection locations, without the need for meticulous placement of the tiles. Other embodiments of the present invention, when grouted, give the appearance that a single grooved tile and/or an assembly of tiles, is made up of numerous individual tiles without the labor expenditures required to set the numerous smaller individual tiles. Yet other embodiments of the present invention advantageously provide for setting the grooved tiles without the unnecessary expense of spacers. The invention, in its various aspects, will be explained in greater detail below with regard to exemplary embodiments.

Exemplary Grooved Tiles

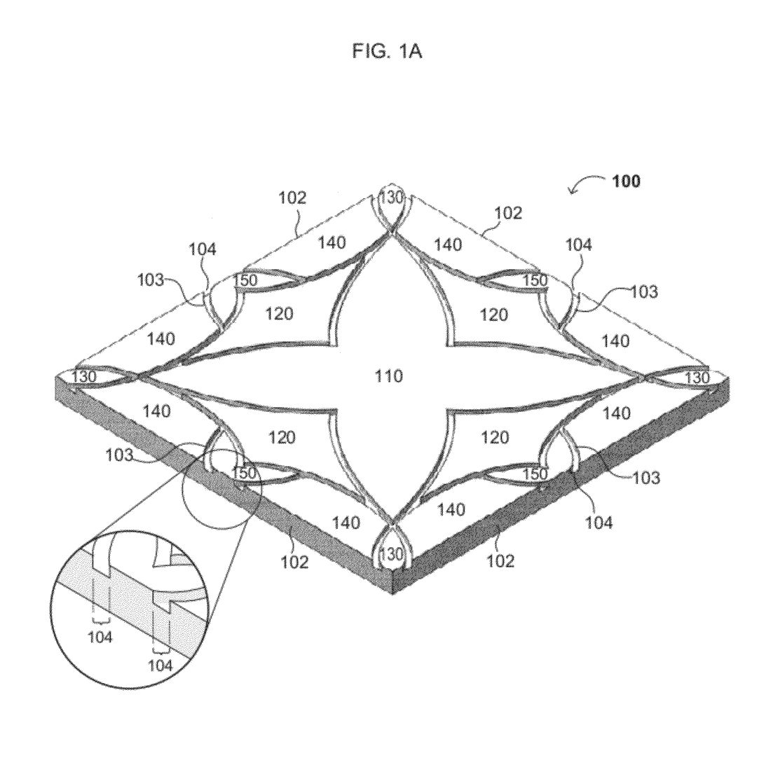

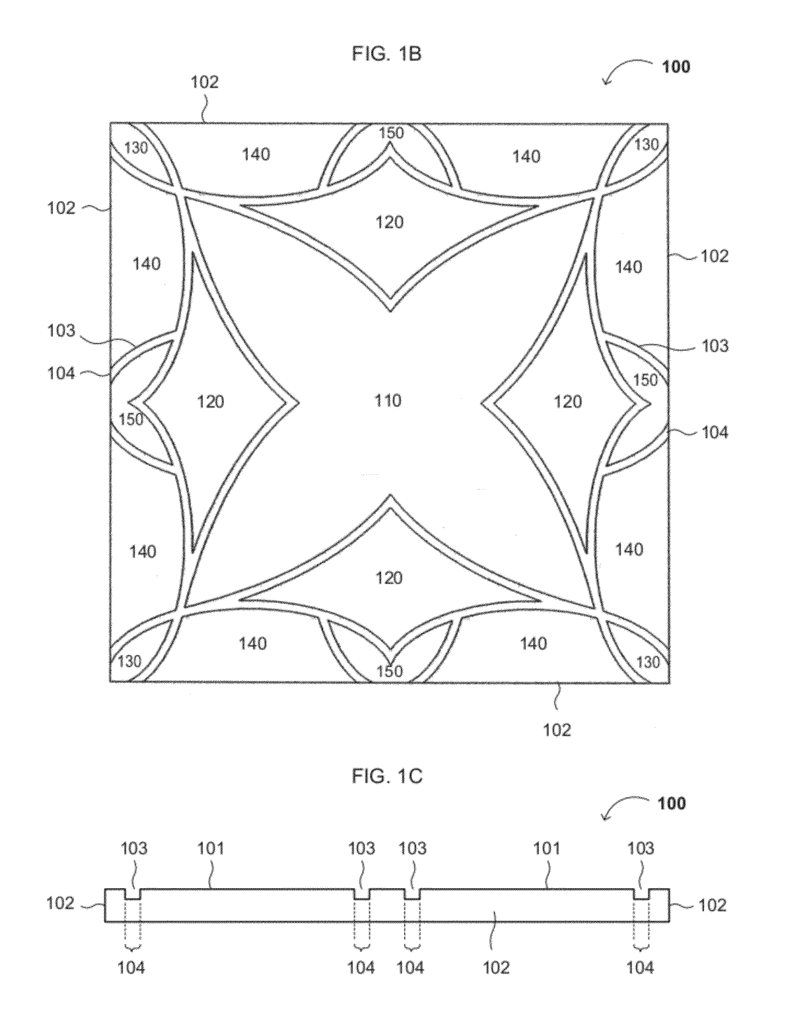

Aspects of the present invention relate to exemplary grooved tiles. Referring to the drawings, wherein like reference characters designate like or corresponding parts throughout the several views, and referring particularly to FIGS. 1A-1C, a first exemplary grooved tile 100 comprises a top surface 101 (see, e.g., FIG. 1C) and four edges 102. However, other embodiments of the present invention may have as few as one edge or numerous edges, for example, up to as many as twenty. In the present invention, an edge may be an open, nonempty subset of the boundary of a simple closed curve that is continuously differentiable. Accordingly, a circular, oval, or pea-shaped tile has one edge, a semicircular tile has two edges, a triangular tile has three edges, a square tile has four edges, and so on. A groove, for example, may be a depression or recess in the tile that does not penetrate the entire depth of the tile and follows a straight line, an algebraic curve and/or other curve, or a combination of straight and curved lines when the depression or recess is viewed in plan. In general, grooves may extend between (i) an intersection location of a first edge of the tile or a first groove in the tile and (ii) an intersection location of a second edge or groove. An intersection location may be a location along the edge of a tile that is configured to match and/or mate with an intersection location of an adjacent tile. In the exemplary embodiment of FIGS. 1A-1C, a plurality of grooves or recesses 103 in the top surface 101 form complete patterns 110 and 120, and partial patterns 130, 140 and 150. However, the present invention is not limited to these numbers or types of complete and/or partial patterns, as various numbers and types of complete and/or partial patterns may be formed by the plurality of grooves.

The exemplary grooved tile 100 may be made from any material in which grooves can be routed, scored, etched, cut, or otherwise formed, such as a bisque, ceramic, porcelain, saltillo, cement, concrete, clay, shale, slate, brick, terracotta, terrazzo, quarry, granite, marble, cantera stone, travertine, onyx, basalt, limestone, flagstone, sandstone, shell stone, glass, metal, stainless steel, cooper, wood, bamboo, plastic, fiberglass reinforced plastic, polyvinyl chloride or epoxy-resin tile or any other suitable material known in the art. However, in some exemplary embodiments a bisque tile is preferred. The tile 100 as viewed from the top surface 101 may be any polygonal shape such as a triangle, square, rectangle, rhombus, quadrilateral, trapezoid, pentagon, hexagon, octagon, or may be a circle, ellipse, oval, or other curved shape. The tile 100 in the exemplary embodiment of FIGS. 1A and 1B is a square, which readily lends itself to patterns which have two or four axes of symmetry when viewed in plan. However, the patterns may be asymmetrical or have a plurality of axes of symmetry (e.g., up to as many as twelve).

The top surface 101 of the tile 100 may have any suitable size known in the art. For example, a tile 100 may have any number of sides or edges 102 each of which independently have a length that may range of from about 0.5″ (1.25 cm) to 24″ (60 cm), or any value or range of values therein (e.g., 6″ [15 cm], 12″ [30 cm], 18″ [45 cm], etc.). In some exemplary embodiments the top surface 101 of the tile 100 may have dimensions of 1″×1″ to 24″×24″, or any value or range of values therein (e.g., 6″×6″, 12″×12″, 18″×18″, 4¼″×4¼″, 2″×4″, 4″×12″, 6″×24″, 8″×10″, etc.). In embodiments in which a tile has a circular, oval, or curved shape, the tile may have a diameter of from about ⅝″ to 24″, or any value or range of values therein (e.g., 1″, 2″, 6″, 10″, 12″, 18″, etc.). In addition, the tile 100 may have any suitable thickness known in the art. For example, a tile 100 may have a thickness of from about 3/16″ to about 1¼″ (0.5 cm to 3 cm), or any value or range of values therein (e.g., 3/16″ to ¼″, ⅜″ to ¾″, 5/16″ to ½″, ½″ to 1″, etc.).

The grooves 103 as shown in FIGS. 1A-1B have widths that are substantially the same. In other embodiments, the width of the grooves 103 may vary in a single groove from a minimum of 10% of an average width of the grooves, to up to 500% of an average width of the grooves. The width of the grooves 103 may also vary from groove to groove in a single tile, from a minimum of 10% of an average width of the grooves, to up to 500% of an average width of the grooves. In some embodiments, the width of the grooves 103 at intersection locations 104 may be the same in all intersection locations 104. However, the invention is not limited as such, and in some embodiments, the width of the grooves 103 may be the same only at intersection locations 104 which are on opposite sides of any axis of symmetry. Still, in other implementations, the width of the grooves 103 may be different at all of the intersection locations 104.

As shown in FIG. 1C, the cross sections of the grooves 103 in the grooved tile 100 may be rectangular. However, in other embodiments, the cross section of the grooves may have a triangular (V-shaped), square, conical, tapered, or semicircular shape (not shown in the figures). The shape of the grooves 103 at the top surface 101 of the grooved tile 100 when viewed in plan may be straight, conic, cubic, quartic, or other planar curved line, or any combination of straight and/or curved lines, as desired. In some embodiments, the width of each groove measured at the top surface may be as little as 0.5% of the total width of the grooved tile. In other embodiments, the width of the groove may be as much as 20% of the total width of the tile. Typically, the grooves will not be less than 1/16 inch wide (about 2 mm) or greater than 1 inch wide (about 2.5 cm).

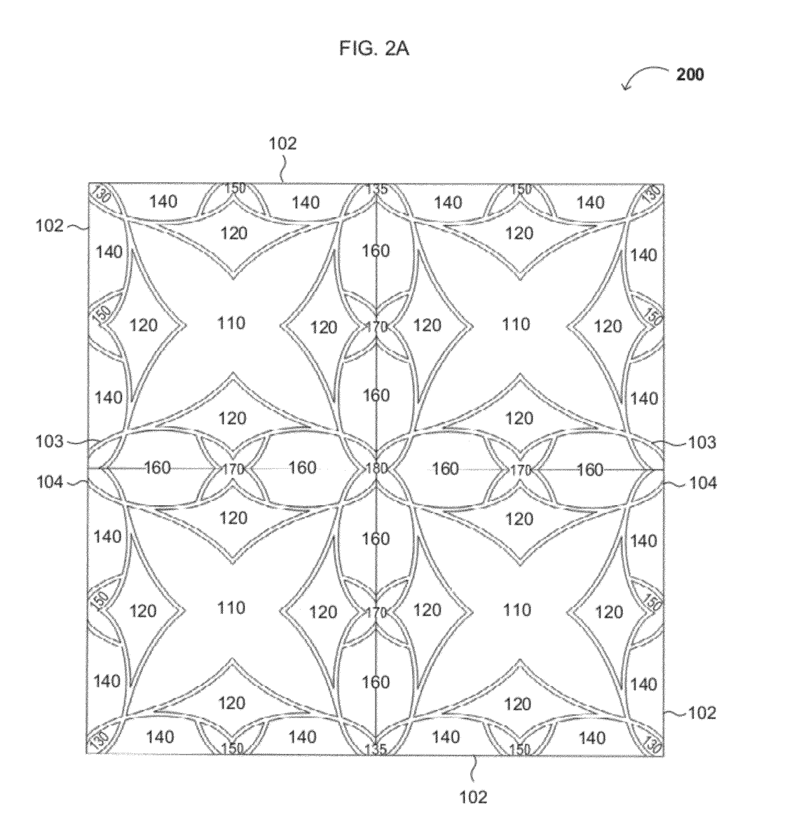

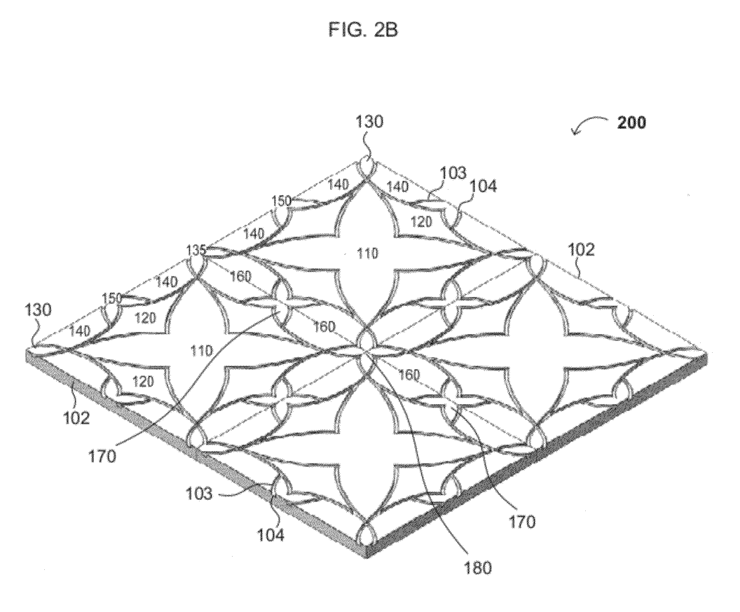

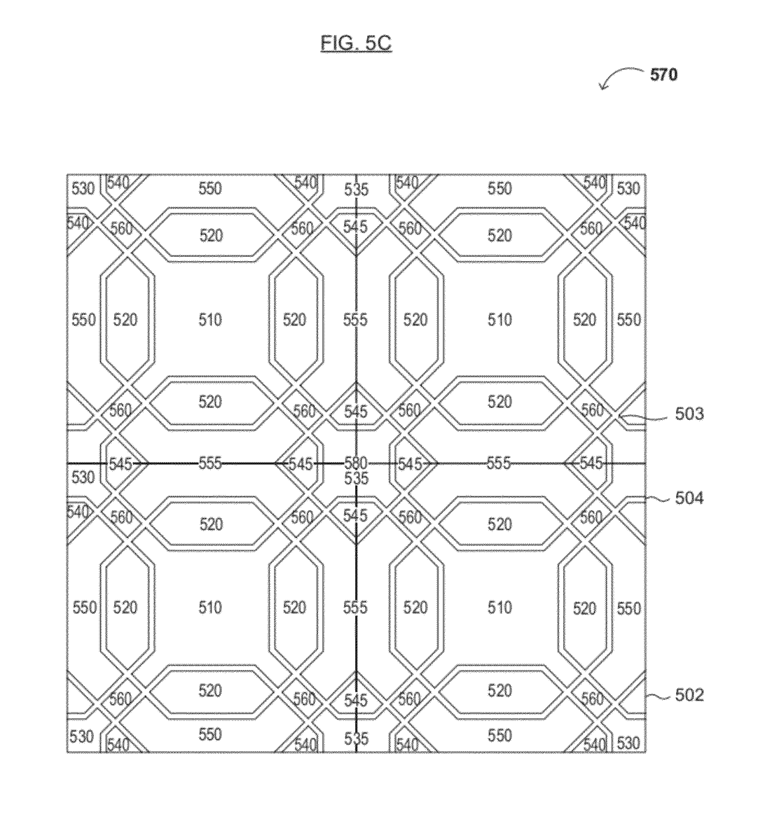

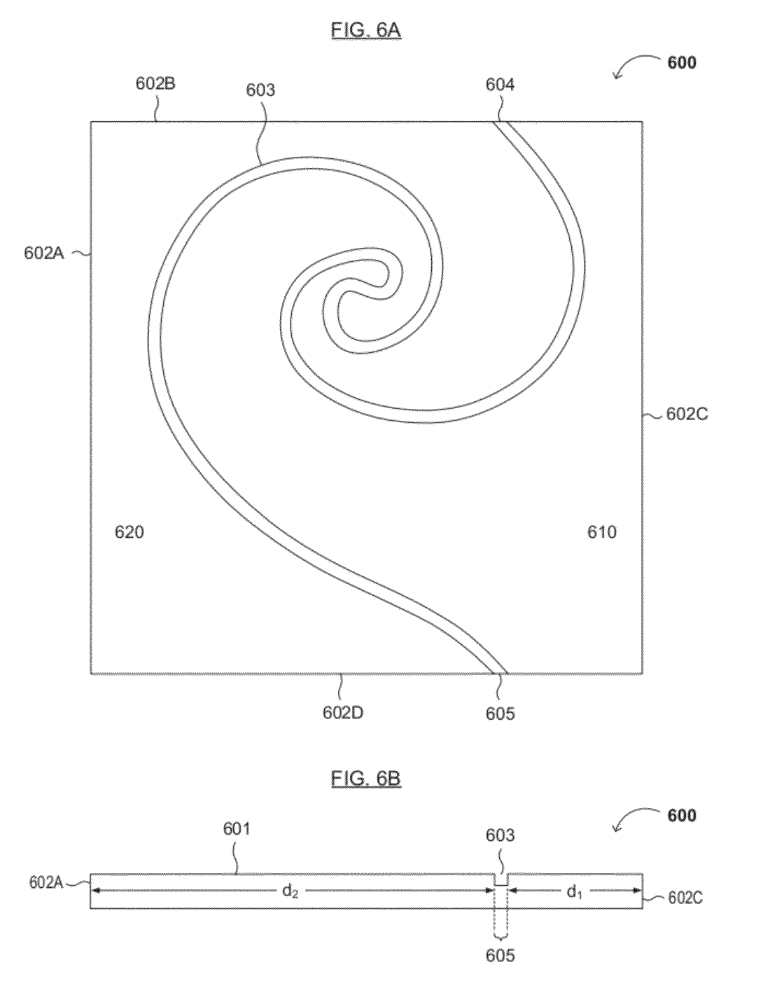

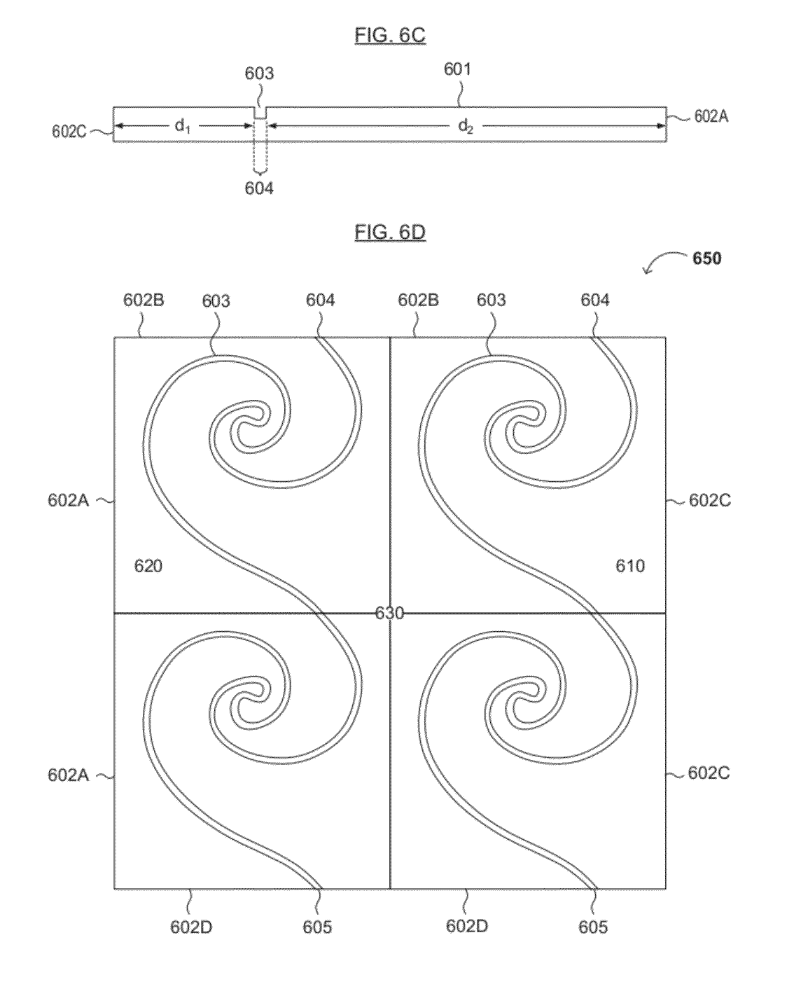

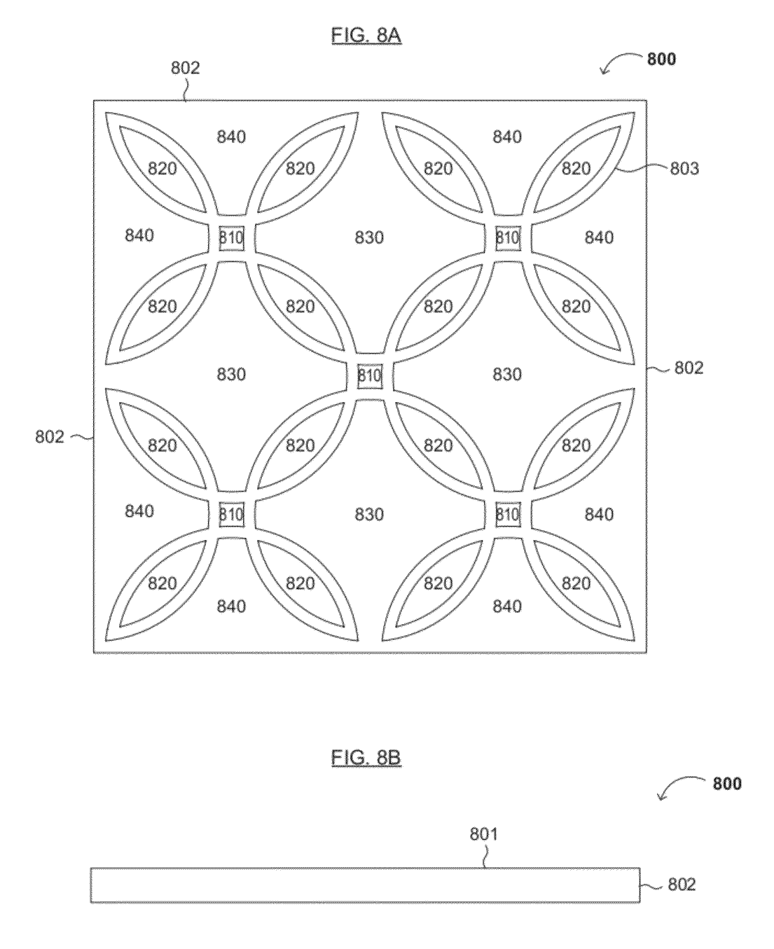

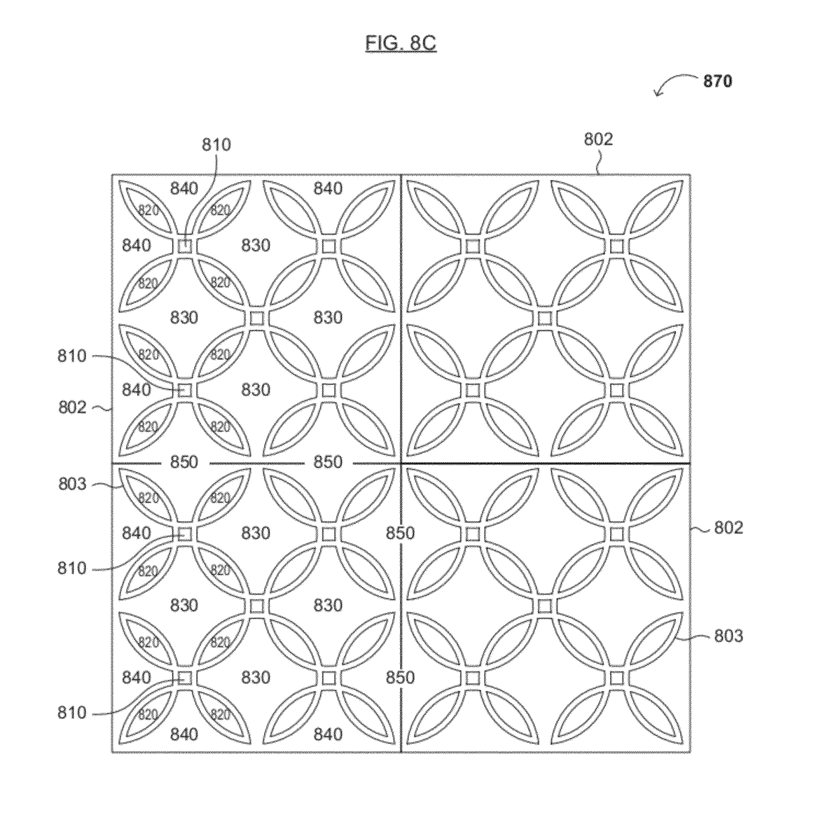

In the exemplary embodiment of FIGS. 1A-1C, the grooves 103 in the grooved tile 100 as a whole are configured to intersect each of the edges 102 of the grooved tile 100 at four intersection locations 104 located the same distance along each edge 102, when measured from an adjacent edge. As a result, all four sides of tile 100 are the same and, thus, when a grooved tile 100 is placed next to an identical grooved tile 100, the grooves 103 of the tile 100 mate with the grooves 103 of an identical grooved tile 100 at the intersection locations 104 when the edges 102 of the tiles 100 are aligned, for example as shown in the exemplary tile assembly 200 of FIGS. 2A-2B (see also the section entitled “Exemplary Grooved Tile Assemblies” herein). However, one skilled in the art can readily envision that any number of intersection locations 104 may exist on a tile edge 102 and may mate with the intersection locations 104 on an edge 102 of an identical grooved tile 100. Further, in some variations, the grooves 103 may be wholly contained within the edge(s) 102 of a grooved tile such that there are no intersection locations 104 (see, e.g., FIGS. 8A-8C and the corresponding description herein), or may intersect at less than all of the edge(s) of the grooved tile at one or more intersection locations, leaving other edge(s) of the grooved tile with no intersection locations (see, e.g., FIGS. 6A-6D and the corresponding description herein). In some embodiments, some or all of the intersection locations 104 on or more of the edges 102 may be located at different distances from an adjacent edge than some or all of the intersection locations 104 on one or more of the other edges 102. In such embodiments, some or all of the grooves 103 may not mate when an edge 102 is aligned with another edge 102 of an identical tile 100.

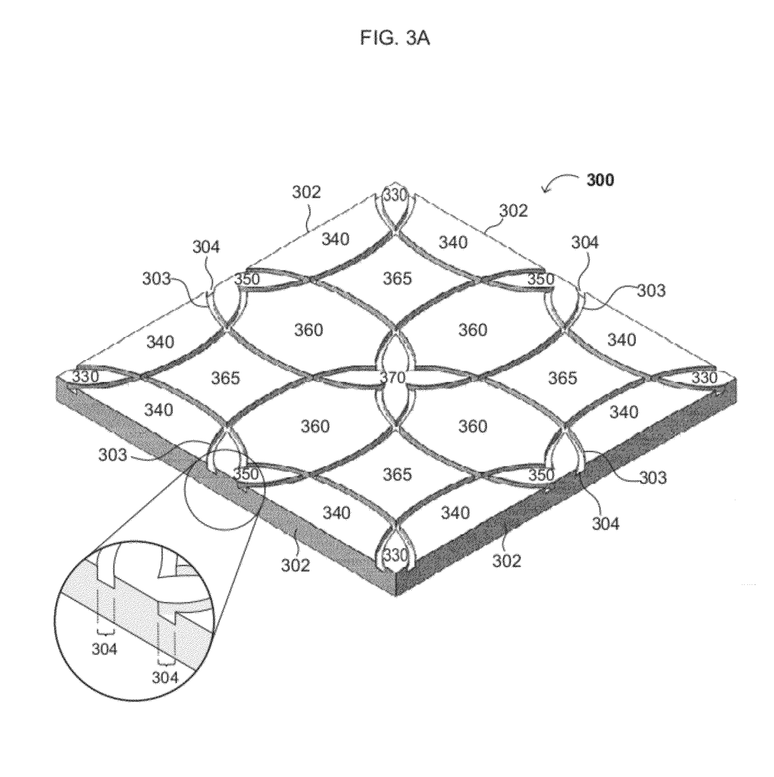

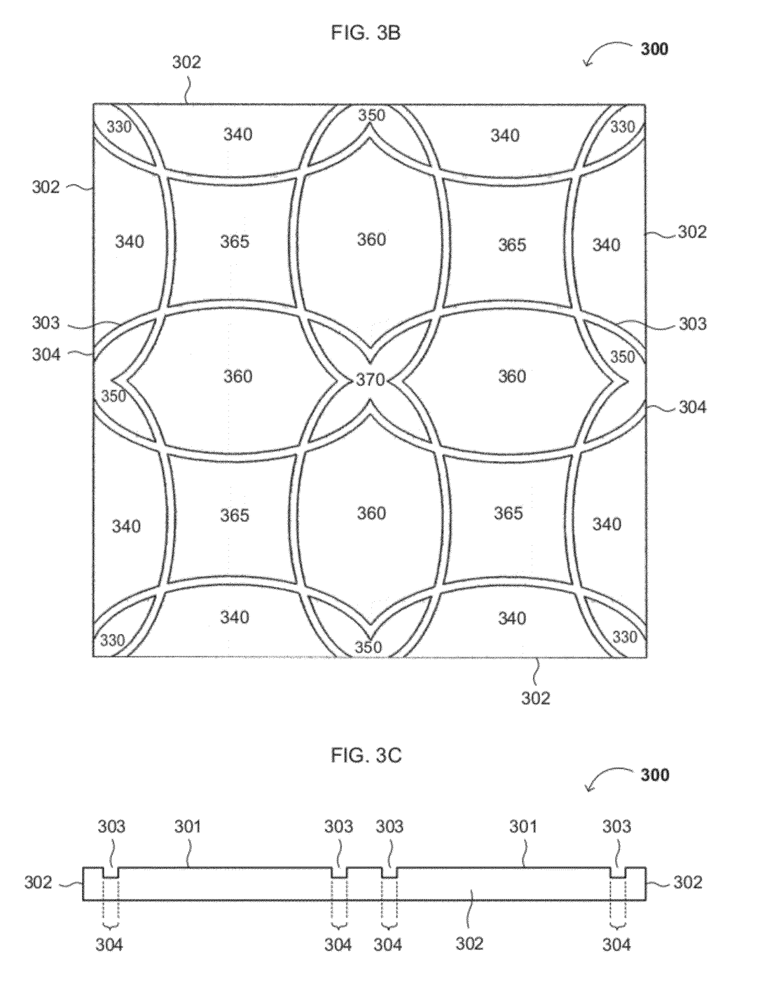

A second exemplary grooved tile is shown in FIGS. 3A-3C. In general, the second exemplary grooved tile 300 comprises a tile having a top surface 301 and four edges 302, and may have any shape described herein with regard to the first exemplary grooved tile 100 (e.g., circle, oval, pea-shape, semicircular, triangular, square, or other polygonal or curved shape, etc.). A plurality of grooves or recesses 303 in the top surface 301 form complete patterns 360, 365 and 370 and partial patterns 330, 340 and 350. Like the exemplary tile 100 of FIGS. 1A-1C, exemplary tile 300 may be made from any material in which grooves can be routed, scored, etched or cut (e.g., bisque, ceramic, porcelain, granite, marble, glass, metal, and/or any other material known in the art). Also as discussed with regard to the tile 100 of FIGS. 1A-1C, the tile 300 in the second exemplary embodiment may have as few as one edge or numerous edges. Furthermore, the grooved tile 300 may have various numbers of complete and/or partial patterns.

The grooves 303 may have any shape, design, and/or size as discussed herein with regard to the first exemplary grooved tile 100. For example, the grooves or recesses 303 may have a rectangular or square shape, as shown in the side view of FIG. 3C, or the grooves may have a triangular, taper, semicircular, or other shape, as desired. As discussed herein with regard to the first exemplary tile 100, the width of each groove may vary from groove to groove (e.g., from 10% to 500%, 50% to 300%, 100% to 200%, or 250% of an average width of the grooves, or any other value or range of values therein). Furthermore, the width of each groove measured at the top surface may be of from 0.5% of the total width of the grooved tile up to 20% of the total width of the tile (e.g., 1% to 15%, 5% to 10%, or any value or range of values therein).

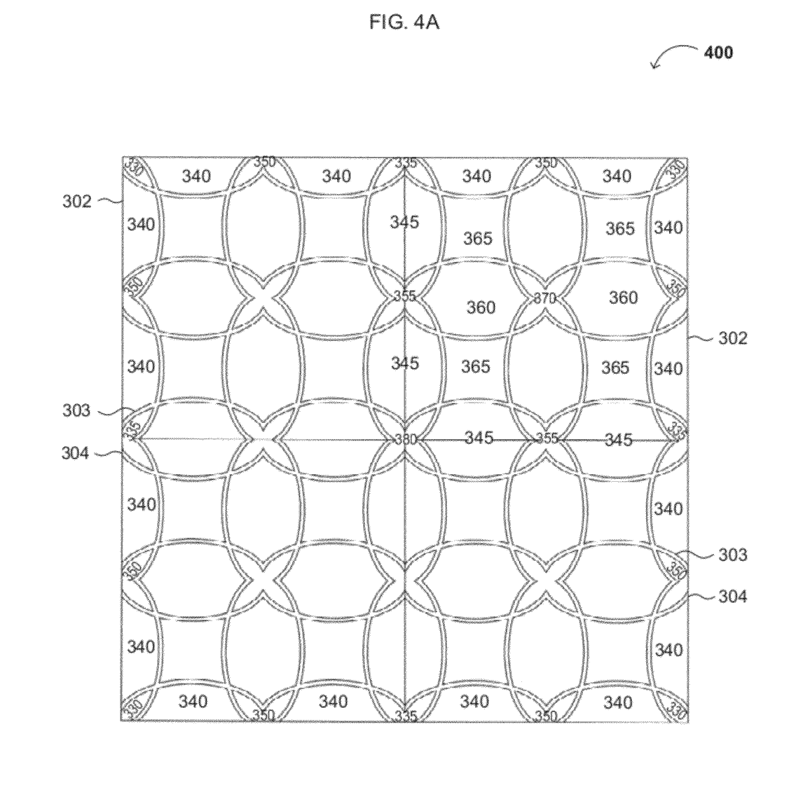

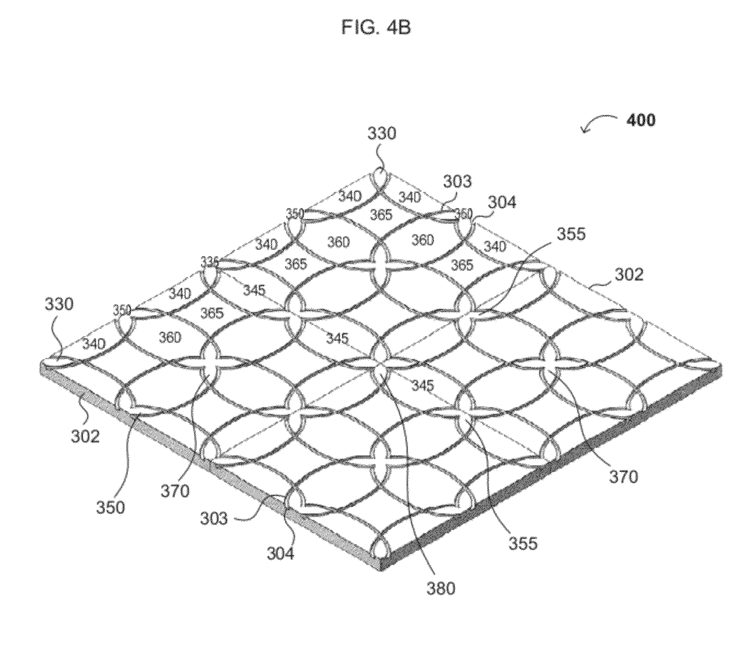

Like the grooves 103 of FIGS. 1A-1C, the grooves 303 in the grooved tile 300 as a whole are configured to intersect each of the four edges 302 of the grooved tile 300 at four intersection locations 304 at each edge 302. Consequently, when one grooved tile 300 is placed next to an identical grooved tile 300, the grooves of the tile 303 mate with the grooves 303 of an identical grooved tile 300 when the edges 302 of the tiles 300 are aligned, for example as shown in the exemplary tile assembly 400 shown in FIGS. 4A-4B (see also the section entitled “Exemplary Grooved Tile Assemblies” herein).

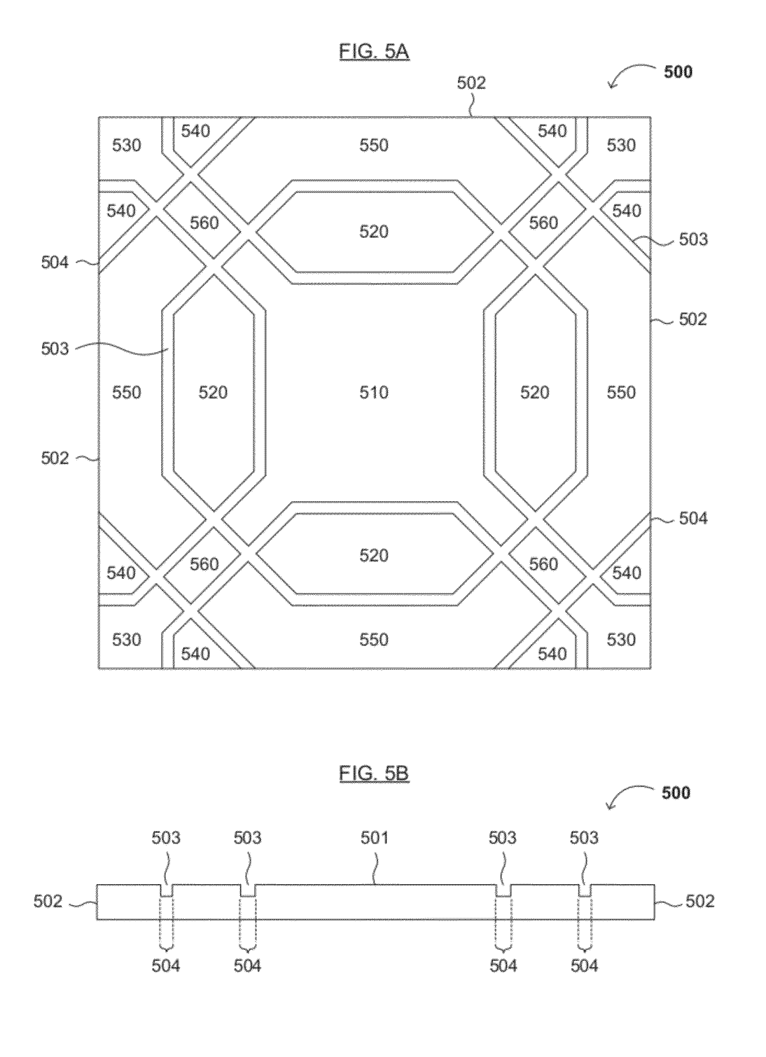

A plan view and a side view of a third exemplary grooved tile 500 are shown in FIGS. 5A-5B, respectively. The grooved tile 500 includes a top surface 501 (see FIG. 5B) and four edges 502 (see FIG. 5A). As shown in FIG. 5A, the tile 500 also comprises a plurality of grooves or recesses 503 in the top surface 501 to form complete patterns 510, 520, and 560 and partial patterns 530, 540, and 550. However, as previously discussed, the third exemplary grooved tile 500 may have any number or type of complete and/or partial patterns formed by the plurality of grooves.

The grooved tile 500 may be made from any material described herein with regard to the embodiments of FIGS. 1A-1C and/or 3A-3C, and the tile surface 500 as viewed from the top surface 501 may have any polygonal shape (e.g., square, rectangle, rhombus, etc.) or curved shaped (circle, oval, etc.) described herein. As shown in the side view of FIG. 5B, the grooves 503 have a rectangular or square shape. However, in other embodiments, the cross-section of the grooves may have a triangular, conical, tapered, or semicircular shape. In addition, as shown in FIG. 5A, in some exemplary embodiments, the shape of the grooves 503 at the top surface 501 of the grooved tile 500 when viewed in plan may be straight and/or angular. However, the shape of the grooves when viewed in plan may also be conic, cubic, quartic, any other planar curved line, or any combination of straight and curved lines as desired.

As discussed above with regard to the embodiment of FIGS. 1A-1C, the width of the grooves on a grooved tile may be the same, or the width may vary from groove to groove on a tile. For example, the width of the grooves may range from a minimum of 10% of an average width of the grooves to up to 500% of an average width of the grooves. In addition, the width of each groove measured at the top surface may be about 0.5% of the total width of the grooved tile or as much as 20% of the total width of the tile. In the grooved tile shown in FIG. 5A, the grooves 503 are configured to intersect each of the edges 502 of the grooved tile 500 at four intersection locations 504 along each edge 502. Consequently, when a grooved tile 500 is adjacent to an identical tile 500, the grooves 503 of the tile 500 mate with the grooves 503 of the identical grooved tile 500 at the intersection locations 504 when the edges 502 of the tiles 500 are aligned. Such an arrangement is shown in the exemplary tile assembly 570 of FIG. 5C (see also the section entitled “Exemplary Grooved Tile Assemblies” herein).

Another exemplary grooved tile 600 is shown in FIGS. 6A-6C. As previously described with regard to other embodiments herein, the grooved tile 600 includes a tile with a top surface 601 and four edges 602A-602D. However, in the exemplary implementations, the tile surface 600 as viewed from the top surface 601 may have any shape described herein with regard to the embodiment of FIGS. 1A-1C (e.g., circle, oval, semicircular, triangular, etc.). Furthermore, the grooved tile 600 may be made from any material previously discussed herein, in which a groove can be routed, scored, etched, cut, or otherwise formed.

As shown in the plan view of FIG. 6A, the grooved tile 600 comprises a single, continuous groove or recess 603 in the top surface 601 of the tile 600. In this embodiment, the continuous groove 603 has a curved or wavy shape, and divides the grooved tile 600 into a first (incomplete) pattern or region 610 and a second (incomplete) pattern or region 620. However, the single groove 603 is not limited to the shape (design or configuration) shown in FIG. 6A, and may have any desired pattern, shape, design, or configuration.

In the exemplary embodiments of a grooved tiled described above (see e.g., FIGS. 1A-1C, 3A-3C and 5A-5B), all edges of the grooved tiles have the same number of grooves located at the same distances from adjacent edge(s). However, in other embodiments, from two to less than all of the edges may have a different number of grooves, and the grooves may be located at different distances from an adjacent edge. For example and referring to FIG. 6A, the groove 603 of grooved tile 600 is configured to intersect each of opposing edges 602B and 602D of the tile 600 at respective first intersection location 604 and second intersection location 605. However, unlike the previous embodiments, the groove 603 in FIG. 6A does not intersect edges 602A and 602C at all. The first intersection location 604 is located along edge 602B at a distance d₁ from the adjacent edge 602C and a distance d₂ from the adjacent edge 602A (see FIG. 6C, which shows a side view of grooved tile 600 looking at edge 602B) and the intersection location 605 is located along edge 602D the same distance d₁ from edge 602C and the same distance d₂ from edge 602A (see FIG. 6B, which shows a side view of grooved tile 600 looking at edge 602D). Therefore, when edge 602B of one tile 600 is placed next to edge 602D of an identical tile 600, the first intersection location 604 of the one tile 600 aligns with second intersection location 605 of an identical tile 600 (see FIG. 6D; see also the section entitled “Exemplary Grooved Tile Assemblies” herein). However, when edge 602B of one tile 600 is placed next to edge 602B of identical tile 600, the first intersection location 604 of the one tile 600 does not align with the first intersection location of the identical tile 600. Similarly, when edges 602A and 602C are placed next to edges 602B or 602D, the first or second intersection locations will have no intersection locations with which to align. One skilled in the art may envision numerous combinations of intersection locations and distances that may provide interesting patterns or combinations of patterns in grooved tiles, in which all, less than all, or none of the grooves in adjacent tiles may align at intersection locations.

As shown in the side views of FIGS. 6B and 6C, the groove or recess 603 has a rectangular or square shape. However, in other implementations, the groove or recess 603 may have any shape previously described herein. Furthermore, the groove 603 may have any width discussed herein with regard to the previous grooved tiles (e.g., 0.5% to 20% of the total width of the tile, or any other value or range of values therein).

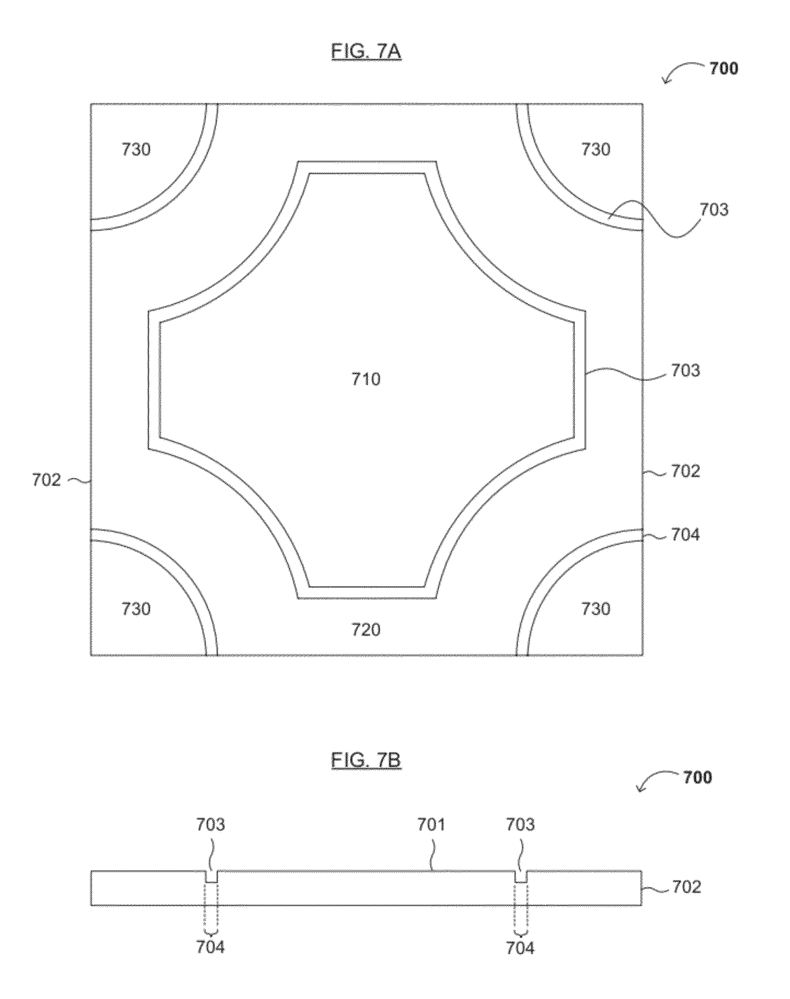

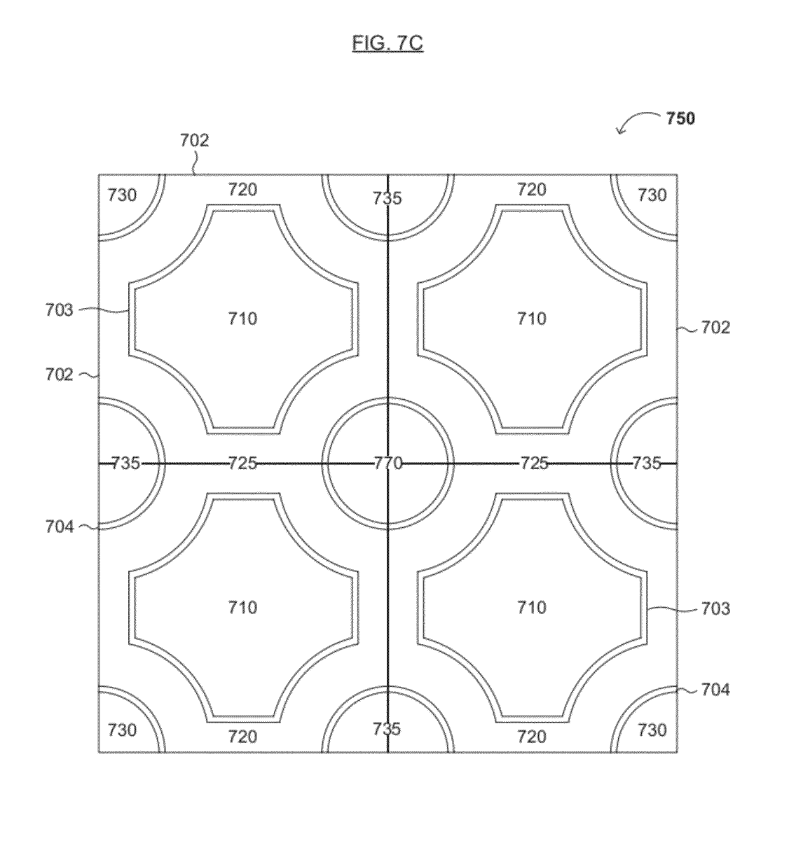

A fifth exemplary grooved tile 700 is shown in FIGS. 7A-7B. As described herein with regard to previous embodiments, the grooved tile 700 includes a tile with a top surface 701 (see FIG. 7B) and a plurality of edges 702 (see FIG. 7A). Specifically, the grooved tile 700 has four edges 702 and the tile 700 when viewed from the top surface 701 has a square shape. However, in other variations, the top surface 701 may have any shape described herein (e.g., circle, oval, semicircular, triangular, etc.). Furthermore, the grooved tile 700 may be made from any material previously described herein in which a groove can be routed, scored, etched, cut, or otherwise formed (e.g., bisque, ceramic, porcelain, brick, terracotta, terrazzo, granite, marble, glass, metal, wood, plastic, etc.). In exemplary embodiments, the grooved tile 700 is bisque.

As shown in the plan view of FIG. 7A, the grooved tile 700 comprises a plurality of grooves or recesses 703 in the top surface 701 of the tile 700. In this embodiment, the grooves 703 have a combination of curved and straight shapes. The plurality of grooves 703 form complete pattern 710 and partial patterns 720 and 730. Referring still to FIG. 7A, the grooves 703 of grooved tile 700 are configured to intersect each of the edges 702 of the tile 700 at two intersection locations 704 (see also FIG. 7B) located the same distance along the edges 702 from an adjacent edge 702. However, in other embodiments, one of the two intersection locations 704 may be located at different distance from an adjacent edge than the other intersection location 704. As described with regard to the previous embodiments, and as shown in FIG. 7C, when one grooved tile 700 is placed next to one or more identical grooved tiles 700, the grooves 703 of the tiles 700 mate when the edges of the tiles are aligned (see also the section entitled “Exemplary Grooved Tile Assemblies” herein).

As shown in the side view of FIG. 7B, the grooves or recesses 703 have a rectangular or square shape. However, as previously discussed herein, in other implementations, the grooves or recesses 703 may have any desired shape (e.g., triangular, tapered, semicircular, etc.). Furthermore, the width of the grooves 703 measured at the top surface may have any width discussed herein with regard to exemplary grooved tiles (e.g., 0.5% to 20% of the total width of the tile, or any value or range of values therein). Furthermore, the width of the grooves or recesses 703 may be the same, or the width may vary from groove to groove on a single tile. For example, each groove may independently have a width that is from 10% to 500% of an average width of the grooves (e.g., 50% to 300%, 100% to 250%, 150% to 200%, or any other value or range of values therein).

Referring now to FIGS. 8A-8B, a sixth exemplary grooved tile 800 is shown in plan and side views, respectively. As previously described herein, the grooved tile 800 includes a tile with a top surface 801 (see FIG. 8B) and four edges 802 (see FIG. 8A). Although the tile 800 shown in FIG. 8A has a square shape in exemplary implementations, the tile 800 as viewed from the top surface 801 may have any shape described herein with regard to the exemplary grooved tiles (e.g., rectangular, circular, oval, semicircular, triangular, etc.). Furthermore, the grooved tile 800 may be made from any material previously discussed herein, in which a groove can be routed, scored, etched, cut, or otherwise formed (e.g., bisque, ceramic, marble, granite, wood, plastic, etc.).

Similar to the grooved tile 600 of FIG. 6A, the grooved tile 800 shown in the plan view of FIG. 8A comprises a single, continuous groove or recess 803 in the top surface 801 of the tile 800. In this embodiment, the continuous groove 803 generally has a curved or wavy shape and changes direction periodically in the pattern. Consequently, the groove 803 intersects itself in multiple locations to form complete patterns 810 and 820, substantially complete patterns 830, and partial (incomplete) patterns 840, as shown in FIG. 8A. However, the single groove 803 is not limited to the shape (design, pattern, or configuration) shown in FIG. 8A, and may have any desired pattern, shape, design, or configuration.

Referring still to FIG. 8A, although the groove 803 of grooved tile 800 is configured to intersect itself at various locations on the tile, the groove 803 does not form any intersection locations with the edges 802 of the grooved tile 800. To further illustrate, FIG. 8B shows a side view of an edge 802 of the grooved tile 800, in which there is no intersection location visible on the edge of the tile 800. Consequently, as shown in FIG. 8C, when one grooved tile 800 is placed next to one or more identical grooved tiles 800, the grooves 803 of the tiles 800 do not mate when the edges of the tiles are aligned because there are no intersection locations at the edges of the tile 800. However, even though the grooves 803 do not mate, partial patterns 840 formed by grooves 803 combine to form substantially complete patterns 850 when grooved tile 800 is placed next to one or more identical grooved tiles 800 (see also the section entitled “Exemplary Grooved Tile Assemblies” herein).

In exemplary embodiments, the groove or recess 803 may have a square, rectangular, triangular, tapered, semicircular, or conical shape, or any other suitable shape known in the art. Furthermore, the width of the groove 803 measured at the top surface may have any width discussed herein with regard to exemplary grooved tiles (e.g., 0.5% to 20% of the total width of the tile, or any value or range of values therein).

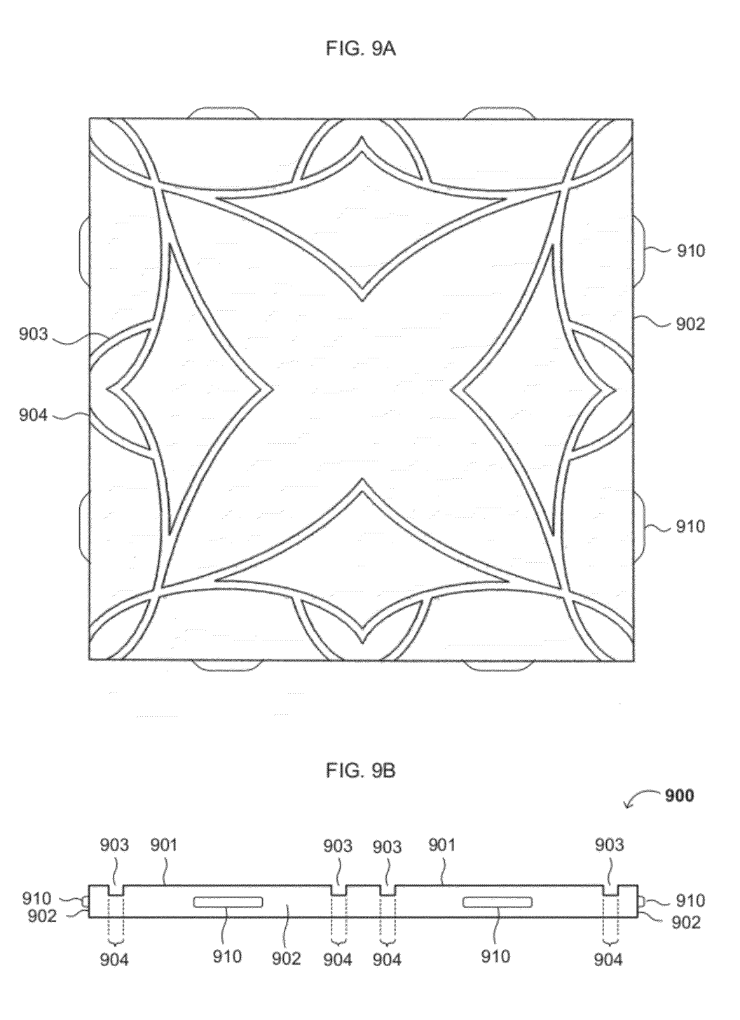

In some embodiments, a grooved tile may include one or more integral spacers to maintain a substantially constant and/or consistent gap between tiles in a grooved tile assembly. For example, the plan and side views of FIGS. 9A-B, respectively, show the grooved tile of FIGS. 1A-1C with integral spacers 910 on the edges 902 of the tile 900. Specifically, as shown in FIG. 9B, the grooved tile 900 has a top surface 901, edges 902, grooves 903 and intersection locations 904, as previously described with regard to the grooved tile 100 of FIGS. 1A-1C. As shown in FIGS. 9A-9B, the edges 902 of the grooved tile 900 each include two integral spacers 910 that maintain a substantially constant and/or consistent gap between the edges 902 of the tiles 900 when one grooved tile 900 is placed next to one or more identical grooved tiles 900 and the edges of the tiles are aligned. The integral spacers 910 can help achieve substantially uniform grout joints when one or more grooved tiles 900 are placed together and grouted to form an assembly of tiles.

The integral spacers may have any suitable length and width (thickness) as needed to provide the desired grout joints between the grooved tiles. For example, in some embodiments, the integral spacers may have a length that ranges of from about 5% of the length of the side of the tile to about 98% of the length of the tile (e.g., 5% to 10%, 10% to 25%, 30% to 50%, or any other value or range of values therein). The integral spacers may have a thickness or width of from about 1/32″ to ¾″ (about 1 mm to 2 cm) or any value or range of values therein. For example, in exemplary embodiments the integral spacers may have a thickness or width of about 1/16″ to 3/16″ (2 mm to 5 mm), about 5/16″ to ½″ (8 mm to 1.25 cm), about ½″ to ¾″ (1.25 cm to 2 cm) or any other value or range of values therein. The integral spacers may be located under intersection locations of the grooves on the edge of the grooved tile, but usually the integral spacers are located along the grooved tile edge at locations other than intersection locations. The integral spacers can be customized to achieve a substantially consistent and uniform grout joint thickness between adjacent tiles without using conventional spacers. The integral spacers may have any shape known in the art. For example, the integral spacers may be any polygonal shape such as a square, rectangle, rhombus, quadrilateral, trapezoid, pentagon, hexagon, octagon, or in some instances, the integral spacers may be a semi-circle, ellipse, oval, or other curved shape. However, square, rectangle, and trapezoid shapes may be preferred.

The integral spacers may be made from any suitable material known in the art. For example, the integral spacers may be bisque, ceramic, porcelain, saltillo, cement, concrete, clay, shale, slate, brick, terracotta, terrazzo, quarry, granite, marble, cantera stone, travertine, onyx, basalt, limestone, flagstone, sandstone, shell stone, glass, metal, stainless steel, cooper, wood, bamboo, plastic, fiberglass reinforced plastic, polyvinyl chloride or epoxy-resin tile. In some variations, the integral spacers are made from the same material as the tile, and can be formed with the tile. In other embodiments, the integral spacers may be made from a different material as the tile, may be formed separately from the tile and then subsequently attached to the tile using any suitable attachment method known in the art (e.g., using an adhesive or other glue, with a screw, dowel, clamp, bracket, or other attachment device, etc.). Although the integral spacers 910 shown in FIGS. 9A-9B are shown with the tile of FIGS. 1A-1C, one or more integral spacers can be included on the edges of any grooved tile described herein.

In some embodiments, an integral spacer on one tile may mate with an indentation or depression (not shown in the figures) in an adjacent tile. In such embodiments, the integral spacers may be used to align adjacent tiles and/or to keep adjacent tiles in alignment in an assembly. In such embodiments, the indentation or depression may have substantially the same thickness or width as the thickness or width of the integral spacer, or the indentation or depression may have a thickness or width greater than or less than the thickness or width of the integral spacer. In embodiments where the integral spacers have substantially the same or greater thickness or width as the integral spacers, the edges of adjacent grooved tiles may meet (or substantially meet), leaving little or no space or gap between the adjacent tiles. In other embodiments where the thickness or width of the depression is less than the thickness or the width of the integral spacer, a constant and/or consistent grout joint may be formed having a thickness or width substantially equal to the difference in the thicknesses or widths of the integral spacers and the indentations or depressions.

Exemplary Grooved Tile Assemblies

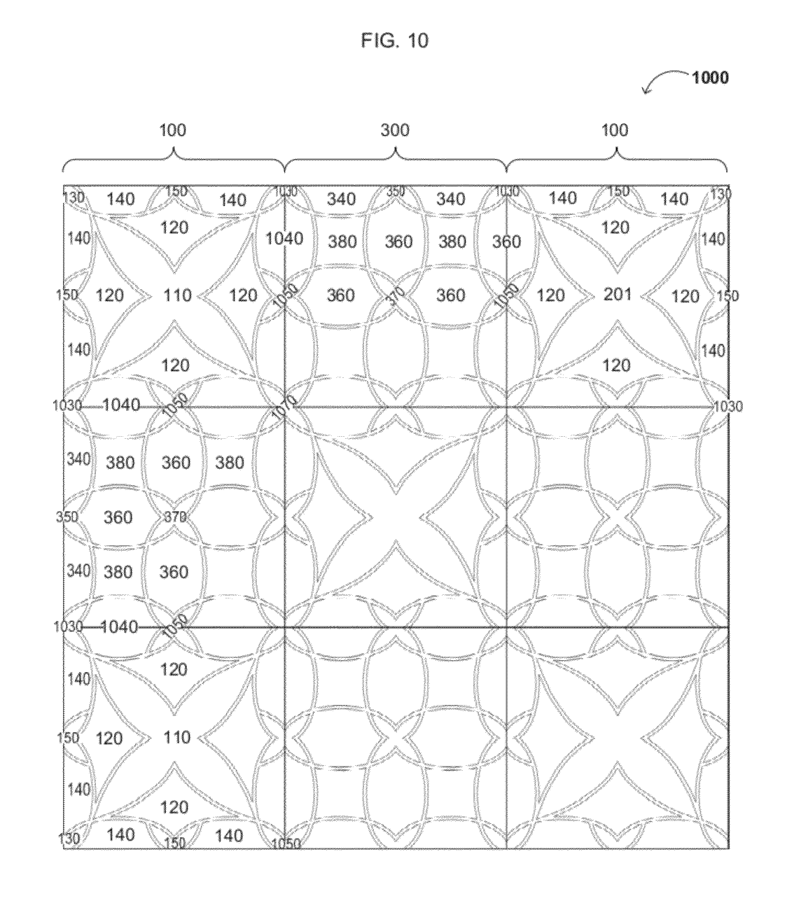

Aspects of the present invention further relate to grooved tile assemblies, which generally include a plurality of grooved tiles (see, e.g., the section entitled “Exemplary Grooved Tiles” above) placed adjacent to one another to form the grooved tile assembly. The tiles in an assembly may be identical to one another, as shown in the grooved tile assembly 200 of FIGS. 2A-2B, or the grooved tiles in a tile assembly may be different, as shown in the grooved tile assembly 1000 of FIG. 10. Exemplary grooved tile assemblies according to embodiments of the present invention are described in detail below.

Referring to FIGS. 2A-2B, an exemplary grooved tile assembly 200 is shown in plan and perspective views, respectively. The exemplary embodiment comprises four of the grooved tiles 100 (see FIGS. 1A-1C), although any number of grooved tiles may be used, depending on the size of the surface to be covered, and the size and shape of the tiles in the assembly. As shown in FIGS. 2A-2B, each grooved tile 100 in the exemplary assembly 200 has a top surface 101 (see e.g., FIG. 1C) and four edges 102. However, other embodiments of a grooved tile assembly may comprise grooved tiles with as few as one edge or with numerous edges.

As previously described above with regard to the exemplary tile 100 of FIGS. 1A-1C, a plurality of grooves or recesses 103 are configured to form complete patterns 110 and 120 and partial patterns 130, 140 and 150 in the grooved tile 100, and the grooves 103 are configured to intersect the edges 102 of the grooved tile 100 at four intersection locations 104 at each edge 102, such that when a grooved tile 100 is placed next to another grooved tile 100, the grooves 103 mate with the grooves 103 of an identical grooved tile when the edges 102 of the tiles 100 are aligned. For example, in some embodiments, at least one of the one or more grooves 103 intersects one or more of the edges 102 of the grooved tile at one or more intersection locations 104. In these embodiments, an assembly may be created as long as the grooves 103 of the grooved tiles in the assembly align at at least a subset of one or more of the intersection location(s) 104 with the grooves of adjacent grooved tile(s) in the assembly at the intersection locations 104.

Referring again to the grooved tile assembly of FIGS. 2A-2B, when the grooves 103 of a grooved tile 100 mate with the grooves 103 of an identical grooved tile 100, the partial patterns 140 and 150 respectively form complete patterns 160 and 170. Similarly, when the grooves 103 of a grooved tile 100 mate with the grooves 103 of an identical grooved tile 100, the partial patterns 130 form partial patterns 135. As is shown in FIG. 2A, when the edges 102 of four grooved tiles 100 are aligned so that grooves 103 mate, the four partial patterns 130 joining in the middle of the grooved tile assembly 200 (e.g., at a center location where four grooved tiles 100 meet) form the complete pattern 180. When the grooved tile assembly 200 is grouted, it advantageously gives the appearance that the assembly is made up of many more than four tiles, each of which has the shape of a complete pattern or a partial pattern. The grooved pattern shown in the assembly of FIGS. 2A-2B can be repeated or otherwise continued in vertical and/or horizontal directions by adding additional tiles to the assembly to cover any desired surface or area (e.g., floor, counter, wall, three-dimensional object, etc.). In other embodiments where the tiles have a different shape (e.g., circular, semicircular, triangular, pentagonal, hexagonal, etc.), additional tiles may be added in other directions (e.g., along one or more axes perpendicular to any side or arc of the tile). In such embodiments, the grooved patterns may also repeat and/or continue along such one or more axes.

The shape of the grooves 103 of the grooved tile assembly 200 may follow a straight, conic, cubic, quartic, or other planar curved line, or a combination thereof. In this first exemplary grooved tile assembly embodiment, the grooved tiles 100 are placed so that there is minimal or no space between the grooved tiles 100. In other embodiments, there may be a gap between adjacent grooved tiles in the assembly. For example, a grooved tile assembly may include one or more tiles with integral spacers to provide a substantially consistent and uniform gap (e.g., for providing or producing a uniform grout joint when the assembly is grouted) between the tiles in the assembly. An example of a grooved tile with integral spacers is shown in FIGS. 9A-B and is discussed in detail above with regard to exemplary grooved tiles. For example, in some exemplary embodiments, the tiles in an assembly may have integral spacers with a thickness or width of from about 1/32″ to ¾″ (about 1 mm to 2 cm) or any value or range of values therein. Consequently, when such tiles are included in an assembly, the gap between them (e.g., to provide grout lines or joints) may range from about 1/32″ to 1.5″ (about 1 mm to about 4 cm). In some embodiments, two or more tiles each having integral spacers with identical widths or thicknesses can be used in an assembly. In such instances, the gap between the tile may be twice (2×) the width of the integral spacer(s), if the integral spacers on adjacent tiles align, or may be equal to the thickness or width of the integral spacers if they are offset from the integral spacers on an adjacent tile. In embodiments where an integral spacer mates with a corresponding indentation or depression in an adjacent tile, there may be little or no gap between the adjacent tiles. However, in other embodiments, the tiles within an assembly can include integral spacers having varying thicknesses, or if desired, an assembly may include a combination of tiles with and without integral spacers. Thus, a grooved tile assembly can be customized to achieve an assembly with no gap between adjacent tiles or an assembly with a gap between the tiles having any desired thickness or width, where the gap provides a substantially consistent and uniform grout joint thickness between adjacent tiles without using conventional spacers.

A second exemplary grooved tile assembly 400 is shown in FIGS. 4A-4B. The exemplary embodiment of FIGS. 4A-4B comprises four of the grooved tiles 300 shown in FIG. 3A. Like the first exemplary grooved tile assembly 200, any number of grooved tiles may be used, depending on the size of the surface to be covered and the size of the grooved tiles used to form the assembly.

As previously described herein with regard to exemplary grooved tiles, and referring also to FIGS. 3A-3B, each grooved tile 300 in the exemplary assembly 400 comprises a top surface 301 (see FIG. 3C) and four edges 302, a plurality of grooves or recesses 303 that are configured to form complete patterns 360, 365 and 370 and partial patterns 330, 340 and 350. The grooves 303 in the grooved tile 300 are configured to intersect the edges 302 of the grooved tile 300 at four intersection locations 304 at each edge 302, such that when a grooved tile 300 is placed next to another grooved tile 300, the grooves 303 mate with the grooves 303 of an identical grooved tile when the edges 302 of the tiles are aligned.

Referring again to FIGS. 4A-4B, when the grooves 303 of a grooved tile 300 mate with the grooves 303 of an identical grooved tile 300, the partial patterns 340 and 350 respectively form complete patterns 345 and 355. Similarly, when the grooves 303 of a grooved tile 300 mate with the grooves 303 of an identical grooved tile 300, the partial patterns 330 form partial patterns 335. As is shown in FIG. 4A, when the edges 302 of four grooved tiles 300 are aligned so that the grooves 303 mate, the four partial patterns 330 meeting in the middle of the grooved tile assembly 400 form the complete pattern 380. The grooved pattern shown in the assembly of FIGS. 4A-4B can be repeated or continued in a vertical and/or a horizontal direction as desired by adding additional tiles to the assembly.

As previously described herein with regard to the grooved tile assembly 200 of FIGS. 2A-2B, the grooved tile assembly 400 (FIGS. 4A-4B) may follow any straight, conic, cubic, quartic, or other planar curved line, or a combination thereof. In addition, the grooved tile assembly 400 as shown in FIGS. 4A-4B does not include gaps between adjacent tiles. However, in some embodiments, there may be a gap between the tiles having any width described herein (e.g., 1/32″ to 1.5″ [about 1 mm to about 4 cm] or any value or range of values therein). Furthermore, if desired, one or more tiles in the assembly 400 of FIGS. 4A-4B may include integral spacers to provide a substantially consistent and uniform gap between the tile without using conventional spacers (see also the grooved tiles in FIGS. 9A-B and the section entitled “Exemplary Grooved Tiles” above).

A third exemplary grooved tile assembly 570 is shown in FIG. 5C, and includes a plurality of grooved tiles 500 (see also FIG. 5A). Although FIG. 5C shows an assembly comprising four grooved tiles 500, the invention is not limited as such, and any number of grooved tiles may be used, depending on the size of the surface to be covered and the size and/or shape of the grooved tiles used to form the assembly.

Referring also to the grooved tile 500 in FIG. 5A, each grooved tile 500 in the exemplary assembly 570 comprises a top surface 501 and four edges 502, a plurality of grooves or recesses 503 are configured to form complete patterns 510, 520, and 560, and partial patterns 530, 540, and 550. The grooves 503 in the grooved tile 500 are configured to intersect the edges 502 of the grooved tile 500 at four intersection locations 504 at each edge 502, such that when a grooved tile 500 is placed next to another grooved tile 500, the grooves 503 mate with the grooves 503 of the identical grooved tile when the edges 502 of the tiles are aligned.

Referring again to FIG. 5C, when the grooves 503 of a grooved tile 500 mate with the grooves 503 of an identical grooved tile 500, the partial patterns 540 and 550 respectively form complete patterns 545 and 555. Similarly, when the grooves 503 of a grooved tile 500 mate with the grooves 503 of an identical grooved tile 500, the partial patterns 530 form partial patterns 535. As is shown in FIG. 5C, when the edges 502 of four grooved tiles 500 are aligned so that the grooves 503 mate, the four partial patterns 530 meeting in the middle of the grooved tile assembly 570 form the complete pattern 580.

As previously described herein with regard to exemplary grooved tile assemblies the grooves 503 of the grooved tiles 500 may follow any straight, conic, cubic, quartic, or other planar curved lined, or a combination thereof. Furthermore, although the grooved tile assembly 570 shown in FIG. 5C does not include gaps between adjacent tiles, in some exemplary implementations there may be one or more gaps between the tiles. In such embodiments, the gap(s) may have any width described herein, for example of from about 1/32″ to 1.5″ (about 1 mm to about 4 cm), or any other value or range of values therein. In addition, if desired, one or more tiles in the assembly 570 of FIG. 5C may include integral spacers to provide a consistent, uniform gap between the tiles without using conventional tile spacers (see also, FIGS. 9A-9B and the section entitled “Exemplary Grooved Tiles” above). Furthermore, as previously discussed with regard to the embodiments of FIGS. 2A-2B and 4A-4B, the grooved pattern of FIG. 5C can be repeated or continued in vertical and/or horizontal directions by adding additional tiles to the assembly to cover any desired surface or area (e.g., floor, counter, wall, etc.).

A fourth exemplary grooved tile assembly 650 is shown in FIG. 6D. The grooved tile assembly 650 includes four of the grooved tiles 600 shown in FIG. 6A. However, as previously described with regard to other exemplary grooved tile assemblies, the invention is not limited as such, and any number of grooved tiles may be used, depending on the size of the surface to be covered and the size and/or shape of the grooved tiles used in the assembly.

Referring also to the grooved tile 600 in FIG. 6A, each grooved tile 600 in the exemplary assembly 650 comprises a top surface 601 and four edges 602A-602D. The grooved tile 600 includes a single continuous groove 603 that has a curved or wavy shape, and generally divides the tile into a first region 610 on one side of the groove and a second region 620 on the other side of the groove. The groove 603 in the grooved tile 600 is configured to intersect the edge 602B of the grooved tile 600 at a first intersection location 604 and the edge 602D at a second intersection location 605, such that when edge 602B of the grooved tile 600 is placed next to the edge 602D of another identical grooved tile 600, the first intersection location 604 aligns with the second intersection location 605 and the groove 603 mates with the groove 603 of the identical grooved tile. Further, in the exemplary embodiment of FIG. 6D, edges 602A are placed next to edges 602C. However, in other embodiments, edges 602A may be placed next to edges 602A of adjacent tiles 600 and/or edges 602C may be placed next to edges 602C of adjacent tiles 600, thereby altering the appearance and location of the patterns of the grooved tile assembly 650. In yet other embodiments, edges 602B of grooved tile 600 may be placed next to edges 602B of adjacent tiles 600 and/or edges 602D may be placed next to edges 602D of adjacent tiles 600, thereby altering in a different manner the appearance and location of the patterns of the grooved tile assembly 650. Depending upon the relative positions of the intersection location(s), embodiments where edges 602B are placed next to edges 602B of adjacent tiles 600 and/or edges 602D are placed next to edges 602D of adjacent tiles 600, intersection locations 604 and 605 may or may not align.

Referring again to FIG. 6C, when the edge 602B of one grooved tile 600 is placed next to the edge 602D of an identical grooved tile 600 and the first intersection location 604 is aligned with the second intersection location 605, groove 603 of the one grooved tile 600 mates with the groove 603 of the identical grooved tile 600, and the tiles 600 are still divided into two regions, the first region 610 on one side of the groove(s) 603 and the second region 620 on the opposing side of the groove(s). When two, four or more of the grooved tiles 600 are arranged in the assembly shown in FIG. 6D, a third region 630 can be formed between the grooves 603 when the edge 602C of one grooved tile 600 is placed next to the edge 602A of an identical tile 600. As previously described herein, the grooved pattern shown in the assembly of FIG. 6D can be repeated or continued, both vertically and horizontally, by adding additional tiles to the assembly as desired.

As previously described herein with regard to exemplary grooved tile assemblies, the grooves 603 of the grooved tiles 600 in assembly 650 may follow any straight, conic, cubic, quartic, or other planar curved lined, or a combination thereof. Furthermore, although the grooved tile assembly 650 shown in FIG. 6C does not include gaps between adjacent tiles, in some exemplary implementations there may be a gap between the tiles. In such embodiments, the gap may have any width described herein, for example of from about 1/32″ to 1.5″ (about 1 mm to about 4 cm), or any other value or range of values therein. In addition, if desired, one or more tiles in the assembly 650 of FIG. 6C may include integral spacers to provide a substantially consistent and uniform gap between the tile without using conventional tile spacers (see also, FIGS. 9A-9B and the section entitled “Exemplary Grooved Tiles” above).

Referring now to FIG. 7C, a fifth exemplary grooved tile assembly 750 including four grooved tiles 700 (FIG. 7A) is shown in plan view. However, as previously described with regard to exemplary assemblies, any number of grooved tiles may be used, depending on the size of the surface to be covered and the size of the grooved tiles in the assembly.

Referring also to the grooved tile 700 in FIG. 7A, each grooved tile 700 in the exemplary assembly 750 comprises a top surface 701 and four edges 702. A plurality of grooves or recesses 703 is configured to form complete pattern 710, and partial patterns 720 and 730. The grooves 703 in the grooved tile 700 are configured to intersect the edges 702 of the grooved tile 700 at two intersection locations 704 at each edge 702. Consequently, when one grooved tile 700 is placed next to another identical grooved tile 700, the grooves 703 of one tile 700 mate with the grooves 703 of the identical tile 700 when the edges 702 of the tiles are aligned.

Referring again to FIG. 7C, when the grooves 703 of a grooved tile 700 mate with the grooves 703 of an identical grooved tile 700, the partial patterns 720 and 730 form partial patterns 725 and 735, respectively. As shown in FIG. 7C, when the edges 502 of four grooved tiles 700 are aligned so that the grooves 703 mate, the four partial patterns 730 meeting in the middle of the grooved tile assembly 750 form the complete pattern 770. The grooved pattern shown in the assembly 750 of FIG. 7C can be repeated, either vertically and/or horizontally, by adding additional tiles to the assembly as needed to cover a desired surface or area.

As previously described herein with regard to exemplary grooved tile assemblies the grooves 703 of the grooved tiles 700 may follow any straight, conic, cubic, quartic, or other planar curved lined, or a combination thereof. In addition, the grooved tile assembly 750 shown in FIG. 7C does not include gaps between adjacent tiles. However, as previously described herein, in some exemplary implementations, there may be a gap between the tiles. In such embodiments, the gap may have any width described herein (e.g., 1/32″ to 1.5″ or any value or range of values therein). In addition, also as previously described herein, one or more tiles in the assembly 750 of FIG. 7C may include integral spacers to provide a consistent, uniform gap (e.g., grout joint) between the tile without using conventional tile spacers (see also the section entitled “Exemplary Grooved Tiles” above).

In some embodiments, the grooves of one or more tiles in an assembly may be wholly contained within the edge(s) of the grooved tiles such that there are no intersection locations. For example, the grooved tile assembly 870 of FIG. 8C includes four of the grooved tiles 800 of FIG. 8A, each of which have a groove 803 that does not include an intersection location with any of the edges 802 of the tile 800. Referring also to the grooved tile 800 in FIG. 8A, each grooved tile 800 in the exemplary assembly 870 comprises a top surface 801 and four edges 802. As previously discussed herein with regard to exemplary grooved tiles, the continuous groove 803 generally has a curved or wavy shape and changes direction periodically in the pattern. Consequently, the groove intersects itself in multiple locations to form complete patterns 810 and 820, substantially complete patterns 830 and partial patterns 840, as shown in FIG. 8A.

Referring still to FIG. 8A, although the groove 803 of grooved tile 800 is configured to intersect itself at various locations on the tile, the groove 803 does not form an intersection location with the edges 802 of the grooved tile 800. Consequently, as shown in FIG. 8C, when one grooved tile 800 is placed next to one or more identical grooved tiles 800, the grooves 803 of the tiles 800 do not mate when the edges of the tiles are aligned, because there are no intersection locations at the edges of the tile 800. However, as shown in the grooved tile assembly 870 of FIG. 8C, when one tile 800 is placed adjacent to an identical tile 800, partial patterns 840 form substantially complete patterns 850. The grooved pattern shown in the assembly 870 of FIG. 8C can be repeated or continued vertically and horizontally by adding additional tiles to the assembly as desired.

As previously described herein with regard to exemplary grooved tile assemblies the grooves 803 of the grooved tiles 800 in the assembly 870 may follow any straight, conic, cubic, quartic, or other planar curved lined, or a combination thereof. In addition, the groove may change direction and may intersect itself at one or more locations. Furthermore, although the grooved tile assembly 870 shown in FIG. 8C does not include gaps between adjacent tiles, in some exemplary implementations there may be a gap between the tiles. In variations including a gap and/or grout joint between the tiles, the gap or grout joint may have any width described herein. In addition, if desired, one or more tiles in the grooved tile assembly 870 of FIG. 8C may include integral spacers to provide a substantially consistent and uniform gap between the tile without using conventional tile spacers (see also, FIGS. 9A-B and the section entitled “Exemplary Grooved Tiles” above).

In some embodiments of the present invention, a grooved tile assembly may include one or more grooved tiles each of which may have a different number and/or style of complete and/or partial patterns. For example, referring now to FIG. 10, an exemplary grooved tile assembly 1000 is shown. Specifically, exemplary assembly 1000 comprises nine grooved tiles, including five of the grooved tiles 100 of FIG. 1A and four of the grooved tiles 300 of FIG. 3A. However, the grooved assemblies of the present invention are not limited to this configuration, and may include any number and variety of grooved tiles, as desired.

Referring still to FIG. 10, when the grooves 103 of the first grooved tile 100 mate with the grooves 303 of the second grooved tile 300, the partial patterns 140 and 150 of the first grooved tile 100 and the partial patterns 340 and 350 of the second grooved tile 300 respectively form complete patterns 1040 and 1050. Similarly, when the grooves 103 of the first tile 100 mate with the grooves 303 of the second grooved tile 300, the partial patterns 130 of the first grooved tile 100 and the partial patterns 330 of the second grooved tile 300 form partial patterns 1030. Furthermore, at the intersection location of 4 tiles in the assembly, partial patterns 130 of the first tile 100 and partial patterns 330 of the second tile 300 meet forming a complete pattern 1070. In this exemplary grooved tile assembly 1000, edges 102 of the first grooved tile 100 are not adjacent to other edges 102 of the first grooved tile 100, and instead, edges 102 are adjacent to edges 302 of grooved tile 300. Likewise, edges 302 of the second grooved tile 300 are not adjacent to other edges 302 of the second grooved tile 300 and instead, edges 302 are adjacent to edges 102 of grooved tile 100. Consequently, the first grooved tile 100 and second grooved tile 300 alternate in a repeating pattern in the third exemplary grooved tile assembly 1000.

In the exemplary embodiment of FIG. 10, the partial patterns 140 and 150 of grooved tile 100 and the partial patterns 340 and 350 of grooved tile 300 respectively form complete patterns 1040 and 1050. Further, partial patterns 130 and 330 form partial patterns 1030. However, it is not always the case that partial patterns form complete patterns. In some embodiments, when the edges of a first grooved tile mate with the edges of a second grooved tile, the partial patterns of the first grooved tile and the partial patterns of the second grooved tile do not form partial or complete patterns, and instead, form new patterns.

As one skilled in the art will recognize, numerous combinations of grooved tiles with different complete and partial patterns may be used to form assemblies of grooved tiles, wherein any number of complete patterns, partial patterns or new patterns may be formed when the intersection locations of each grooved tile is mated with the intersection locations of other adjacent grooved tiles. Consequently, the present invention can advantageously create a multitude of easily formed grooved tiled assemblies, without the need to meticulously place tiles in a predesigned pattern, without the need to set a much larger number of smaller tiles to obtain the aesthetic appearance of assemblies made with smaller tiles, and without the need to use a mesh, netting, or paper backing.

Exemplary Methods of Manufacturing a Grooved Tile

Aspects of the present invention further relate to methods of manufacturing a grooved tile. An exemplary method of manufacturing a grooved tile in accordance with one embodiment of the present invention comprises securing one or more tile blanks in a groove-forming device, each tile blank having a top surface (e.g., top surface 101 in FIG. 1C, or top surface 301 in FIG. 3C) and at least one edge (e.g., edges 102 in FIGS. 1A-1C, or edges 302 in FIGS. 3A-3C), forming one or more grooves or recesses (e.g., grooves 103 in FIGS. 1A-1C, or grooves 303 in FIGS. 3A-3C) in the tile blank, wherein the grooves or recesses are configured to (i) form one or more complete patterns (e.g., complete patterns 110 and 120 in FIGS. 1A-1B and 2A-2B, or complete patterns 360, 365 and 370 in FIGS. 3A-3B and 4A-4B) and/or one or more partial patterns (e.g., partial patterns 130, 140 and 150 in FIGS. 1A-1B and 2A-2B, or partial patterns 330, 340 and 350 in FIGS. 3A-3B) in the top surface of the tile blank(s).

The tile blank(s) may be secured by any method known in the art that ensures the tile blank(s) will remain immobile while grooves or recesses are created in the tile(s). For example, the tile blank(s) can be placed on a flat surface or other platform, and held in place using a clamp, vice, tape, suction mechanism, vacuum system, or other device configured to secure the tile blank(s) to the platform. In other embodiments, the tile blank(s) can be placed in or on a fitted and/or adjustable platform or other flat surface that includes one or more recesses that are configured to secure the tile blank(s).

In some embodiments, the grooves are formed so that at least one groove intersects at least one edge at one or more intersection locations (e.g., intersection locations 104 in FIGS. 1A-1C and 2A-2B, intersection locations 304 in FIGS. 3A-3C and 4A-4B), or intersection locations 604 and 605 in FIGS. 6A-6C. In other embodiments, the grooves are wholly contained within the edge(s) of the grooved tile and do not intersect any edge (see, e.g., FIGS. 8A-8C). In yet other embodiments, the grooves are formed such that at least one groove mates with at least one of the grooves in a grooved tile with identical intersection location(s) along an adjacent edge when the intersected edges of the grooved tile and the grooved tile with identical intersection locations are placed next to and/or aligned with each other.

In some embodiments, the grooves may be formed by routing the grooves with a router. In other embodiments, the grooves may be scored, etched, or cut using conventional scoring, etching or cutting equipment capable of forming patterned grooves or recesses in the tile. For example, the grooves or recesses may be formed by sand etching or blasting with a sand etcher or sandblaster, laser etching or engraving, laser cutting, diamond etching (e.g., using a diamond-tipped drill), (hand) carving, grinding, water jet cutting, and/or embossing the material with an embossing machine or roller. In other embodiments, the grooves or recesses may be formed by a chemical etching process, for example using hydrofluoric acid (e.g., a dilute aqueous hydrofluoric solution, which may be buffered with ammonia or ammonium fluoride) or other tile etching solution suitable for use with the tile material. The preferred method for forming the grooves in the tile generally depends on the material or composition of the tile and/or the general design of the grooves to be formed in the tile. For example, when forming grooves in a marble tile, routing, sand etching, or laser etching may be preferred, but for a metal tile, embossing with an embossing machine or roller may be effective. To further illustrate, etching or engraving (e.g., with a laser, diamond-tipped drill, sand etcher, etc.) may be effective for forming grooves with straight lines or edges, where water jet cutting or chemical etching may be more effective for forming curved lines.

In one preferred embodiment of the invention, the groove-forming device comprises a computer numerical control (CNC) router. The shape of the grooves to be cut in the tile blank may be first drawn using a software program such as a computer aided design (CAD) software program. The drawing may then be saved in an electronic file compatible with computer aided manufacturing (CAM). In particular, the electronic file can be compatible with a CAM software program that produces line code. Alternatively, the CAD and CAM processes can be completed with a single software program that has both CAD and CAM capabilities. Typically, the CNC router recognizes the line code as an instruction for the movement of one or more cutting (routing) tools, which then create(s) the grooves in the tile blank (e.g., by following the tool path[s] as instructed by the line code). In some embodiments, the tile may be secured in the CNC router, or held in place on or above a work table in proximity to the router, by suction cups or other securing mechanism known in the art. In other embodiments, a vacuum hold-down system may be configured to hold the blank in place. In still other embodiments, clamps or tape may be used to secure the tile in the groove-forming device. In some embodiments, multiple tiles (which may be arranged in an x-by-y array, where each of x and y are independently an integer of at least 2, 3, 4 or more; e.g., 2 tiles by 2 tiles; 2 tiles by 3 tiles; 3 tiles by 4 tiles, 6 tiles by 6 tiles, etc.) are simultaneously secured in the groove-forming device.

The grooves are generally formed in the top surface of the tile and may have any shape and/or size described herein with regard to exemplary grooved tiles. For example the grooves may be formed with a tool that imparts a triangular, square, conical, tapered, or semicircular cross-sectional shape to the groove. In addition, each of the grooves may have a straight, conic, cubic, quartic, or other planar curved line, or any combination of straight and/or curved lines at the top surface of the tile when viewed in plan. Furthermore, the grooves may have a width (e.g., when measured at the top surface of the tile) that is about 0.5% of the total width of the grooved tile up to a width that is as much as 20% of the total width of the tile. In exemplary embodiments, the grooves may range from about 1/16″ to about 1″ (2 mm to 2.5 cm) in width.

The depth of the grooves or recesses generally depends on the thickness of the tile blank. In exemplary embodiments the grooves may be formed with a depth ranging from about 10% to 90% of the thickness of the tile blank (e.g., 25% to 75%, 30% to 60%, 50%, or any other value or range of values therein). Consequently, the depth of the grooves or recesses may range of from about 0.2″ to about 1.2″ depending on the thickness of the tile blank. In some embodiments, the grooves on an individual tile may be formed having identical depths. However, the invention is not limited as such. In some variations, each groove or recess in an individual tile may have a different depth, or some grooves may have the same depth and other grooves may have one or more different depths.

In some embodiments, the method of manufacturing the grooved tile may further comprise designing the grooved tile by (a) arraying one or more geometric shapes to create a repeating pattern, and (b) scaling the repeating pattern of geometric shapes to fit the size of the tile. The initial geometric shapes used to create the repeating pattern(s) may be drawn by hand or using a software program such as a CAD program. The repeating pattern may comprise one or more complete patterns and/or one or more partial patterns as described above with regard to exemplary grooved tiles. In some embodiments, the method may further comprise (a) determining at least one intersection location for the one or more partial patterns, and (b) adjusting the one or more partial patterns such that for each partial pattern, at least one of the groove(s) of the partial pattern mates with at least one of the groove(s) of a partial pattern in a grooved tile with identical intersection locations when the grooved tile and the grooved tile with identical intersection locations are adjacent to and/or aligned with each other.

In some embodiments, the method may further comprise glazing and/or firing the tiles (e.g., in a kiln) either before or after forming the grooves or recesses. Consequently, the present method is advantageous over conventional methods, which generally require scoring after glazing and firing processes are completed. In other embodiments, the method may further comprise polishing or otherwise finishing (e.g., applying a finish, painting, embellishing, etc.) the tiles either before or after forming the grooves in the tile blank.

Exemplary Methods of Forming a Grooved Tile Assembly

An exemplary method of forming a grooved tile assembly comprises (a) applying an adhesive on the back surface of the grooved tile and/or on a surface to be covered by the grooved tiles (not shown in the Figures); (b) arranging the grooved tiles on the surface such that at least one edge of each grooved tile is adjacent to at least one edge of one or more other grooved tiles in the assembly (see the exemplary grooved tile assemblies of FIGS. 2A-B, 4A-B, 5C, 6D, 7C, 8C, and 10); and optionally (c) placing grout in, between and/or on top of the grooved tiles (also not shown in the figures) In some embodiments where the method includes placing grout in, between and/or on top of the grooved tiles, the method may also include wiping the surface of the tiles to remove excess and/or unwanted grout or grout residue from the surface. In some embodiments, the grooved tiles are glazed and fired (e.g., in a kiln) prior to placing, arranging and/or installing the tiles on a surface. In other embodiments, the method may further comprise polishing the tiles and/or applying a finish to the tile assembly.

In some embodiments, at least one of the groove(s) of the grooved tiles in the assembly may intersect at least one edge of the grooved tiles at one or more intersection locations, and the method of forming the assembly may further comprise aligning some or all of the intersection locations along the edges of adjacent tiles. However, in other embodiments, the groove(s) of the grooved tiles in the assembly may not intersect any edge(s) of the grooved tiles in the assembly.

In some embodiments, the adhesive may be spread or troweled in a substantially even layer on the back surface of the tile or the surface on which the tile is to be placed. The adhesive may comprise any adhesive compound or substance known in the art. For example, the adhesive may comprise a mastic (e.g., organic mastic), a thin-set compound or mortar (e.g., standard gray, latex additive, epoxy mortar, water-mixed mortar, acrylic-mixed mortar, dry-set mortar, etc.), or in some instances the adhesive may be the same or similar grout used to make the assembly, or it may be a peel and stick-type adhesive. The type of adhesive used will generally depend on the type of material used for the tile and/or the surface (e.g., setting bed), and/or location (e.g., environmental conditions) in or on which the tile will be adhered. For example, the adhesive may be selected based on whether the tile will be applied indoors or outdoors, on a wall or a floor, or in an area of relatively high or low humidity, and/or in an area having relatively high or low temperatures. Furthermore, the type of adhesive selected may depend on the size and weight of the tile, the composition of the tile, and/or the relative evenness of the back of the tile. It is within the ability of one skilled in the art to determine an adhesive suitable for use with any given tile assembly.

In further implementations, the grooved tiles may be placed adjacent to each other with minimal or no space between the tiles, and in other embodiments, the tiles may be placed with a gap between adjacent grooved tiles having a width that is from about 1/16 of an inch (about 2 mm) to up to 1½ inches (about 4 cm), as previously described herein with regard to exemplary grooved tile assemblies. The tiles in the assembly may have any size, shape, and or groove pattern described herein, and may be placed in any arrangement desired (see, e.g., the sections entitled “Exemplary Grooved Tiles” and “Exemplary Grooved Tile Assemblies” above).

In yet other implementations, the method of forming a grooved tile assembly may comprise placing a first grooved tile and a second grooved tile on the wall, floor, countertop or other surface. Any number of grooved tiles may be used, depending on the size of the surface to be covered and the size and shape of the tile used in the assembly. In some embodiments, the complete patterns of the first grooved tile and the complete patterns of the second grooved tile may be the same (see, e.g., the tile assemblies of FIGS. 2A-B, 4A-B, 5C, 6D, 7C, and 8C). In other embodiments, the complete patterns of the first grooved tile and the complete patterns of the second grooved tile may be different (see, e.g., the tile assembly of FIG. 10). In yet other embodiments, the edges of the first grooved tile are not adjacent to the edges of other first grooved tiles and instead, the edges of the first grooved tile are adjacent to edges of the second grooved tile. Consequently, the first grooved tile(s) and the second grooved tile(s) can alternate in a repeating pattern. However, an assembly of grooved tiles is not limited to just first grooved tiles and second grooved tiles. An assembly may comprise any number of different grooved tiles (e.g., 3, 4, 5 or more) that may alternate to form a repeating pattern.

Embodiments of the present method may also comprise placing grout between the tiles that is the same color as the grooved tile, whereas other embodiments may comprise placing grout between the tiles that is a different color than the grooved tiles. The grout color may be any available color known in the art. Furthermore, the grout may be any type of grout known in the art (e.g., sanded, unsanded, epoxy, cement-based, furan resin, acrylic latex, standard, flexible, etc.), and generally depends on the type of tile material used in the tile assembly, the size of the grout joint or gap to be filled, and the environmental conditions in which the assembly will be placed. For example, unsanded grout may be preferred in a grout joint or gap that is relatively narrow (e.g., less than ⅛″ wide), where a sanded grout may be chosen for gaps larger than ⅛″ in width. In addition, a sanded grout may be preferred with heavier tiles (e.g., natural stone, marble, glass, etc.) because the sand in the grout may help support the weight of the tile. In outdoor areas or areas of relatively high humidity, an epoxy may be the preferred grout material because it is generally water resistant. It is within the ability of one skilled in the art to determine a suitable grout for any given tile assembly.

In some embodiments, the method may optionally comprise removing (e.g., wiping away, etc.) any excess grout and/or adhesive from the tile surface(s) using any suitable method known in the art. In other embodiments, the method may further comprise polishing or otherwise finishing (e.g., applying a finish, painting, embellishing, etc.) the tiles in the assembly either before or after forming the grooves in the tile blank. In still further embodiments, the method may include mating one or more integral spacers on one tile with one or more indentations or depressions on an adjacent tile.

### CONCLUSION

Embodiments of the present invention advantageously provide a tile having one or more grooves in the surface that form one or more complete patterns and/or one or more partial patterns. In some embodiments, the grooves or recesses do not intersect any edge(s) of the grooved tile. Other embodiments may include at least one groove which intersects at least one of the edges of the tile, and mates with at least one groove in a grooved tile with identical intersection locations when the edges of the grooved tiles are placed next to and/or aligned with each other. Further embodiments of the present invention provide a grooved tile that gives the appearance of being formed from a plurality of individual tiles. Still further embodiments of the present invention provide methods of manufacturing grooved tiles, and methods of forming grooved tile assemblies using such grooved tiles. Embodiments of the present invention can advantageously provide grooved tiles having grooves that easily mate with the grooves in other identical or different grooved tiles when the intersection locations of adjacent tiles are aligned. Embodiments of the present invention can also advantageously provide tiles that give the appearance of being made of numerous smaller individual tiles, thus eliminating the need for and the cost of separately placing multiple smaller individual tiles and/or spacers between the tiles, or first backing the tiles with mesh, netting, or paper backing.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A grooved tile, comprising:
a) a top surface;
b) at least one edge; and
c) one or more grooves or recesses in the top surface, the one or more grooves or recesses configured to form one or more complete patterns and/or one or more partial patterns.

2. The grooved tile of claim 1, wherein the grooves do not extend to and/or intersect with any edge of the grooved tile.

3. The grooved tile of claim 1, wherein at least one of the one or more grooves intersects one or more of the at least one edge of the grooved tile at one or more intersection locations.

4. The grooved tile of claim 3, wherein at least one of the one or more grooves mates with at least one of the one or more grooves in a grooved tile with identical intersection locations at at least a subset of the one or more intersection locations when an edge of the grooved tile is placed adjacent to and/or aligned with an edge of the grooved tile with identical intersection locations.

5. The grooved tile of claim 1, wherein the one or more grooves, when grouted, give the appearance that the grooved tile is made up of a plurality of individual tiles, each of the individual tiles having the shape of a complete pattern or a partial pattern.

6. The grooved tile of claim 1, wherein each of the one or more grooves follows a straight, conic, cubic, quartic or other planar curved line, or a combination thereof.

7. The grooved tile of claim 1, wherein each groove has a triangular, square, conical, tapered, semicircular or rectangular cross section.

8. The grooved tile of claim 1, wherein each groove has a width measured at the top surface of from 0.5% to 20% of a total width of the tile.

9. A grooved tile assembly, comprising a plurality of grooved tiles, wherein each grooved tile comprises:
a) a top surface;
b) at least one edge;
c) one or more grooves or recesses in the top surface, the grooves or recesses configured to form one or more complete patterns and/or one or more partial patterns in the top surface; and
the grooved tiles are arranged such that one or more of the at least one edge of each grooved tile is adjacent to one or more of the at least one edge of one or more other grooved tiles in the assembly.

10. The grooved tile assembly of claim 9, wherein (i) at least one of the one or more grooves of each grooved tile in the assembly intersects one or more of the at least one edge of another one of the grooved tiles at one or more intersection locations, and (ii) at least one of the one or more grooves of each grooved tile in the assembly mates with at least one of the one or more grooves in another grooved tile in the assembly at at least a subset of the one or more intersection locations.

11. The grooved tile assembly of claim 10, wherein the plurality of grooved tiles comprises one or more of a first grooved tile and one or more of a second grooved tile, and wherein at least one of the one or more of the partial pattern(s) of the first grooved tile(s) and at least one of the one or more of the partial pattern(s) of the second grooved tile(s) form one or more complete patterns, one or more new patterns, or a combination thereof when at least one of the one or more intersection locations the first grooved tile(s) and at least one of the one or more intersection locations of the second grooved tile(s) are adjacent to each other.

12. The grooved tile assembly of claim 11, wherein the new and/or complete pattern(s) formed from the partial patterns comprise one or more axes or planes of symmetry.

13. A method of manufacturing a grooved tile, the method comprising:
a) securing a tile blank in a groove-forming device, the tile blank having a top surface and at least one edge;
b) forming one or more grooves or recesses in the top surface, wherein the one or more grooves or recesses are configured to form one or more complete patterns and/or one or more partial patterns in the top surface.

14. The method of claim 13, wherein the one or more grooves or recesses are further configured to intersect one or more of the edges at one or more intersection locations.

15. The method of claim 13, wherein the grooves are formed using a router.

16. The method of claim 13, further comprising designing the grooved tile by:
a) arraying one or more geometric shapes to create a repeating pattern; and
b) scaling the repeating pattern of geometric shapes to fit a size of the grooved tile.

17. The method of claim 16, wherein the grooved tile comprises one or more partial patterns, and the method further comprises (i) determining at least one intersection location for the one or more partial patterns, and (ii) adjusting the one or more partial patterns such that for each partial pattern, at least one of the one or more grooves of the partial pattern mates with at least one of the one or more grooves of a partial pattern in a grooved tile with identical intersection locations when an edge of the grooved tile and an edge of the grooved tile with identical intersection locations are adjacent to and/or aligned with each other.

18. A method of forming the grooved tile assembly of claim 9, comprising:
a) applying an adhesive on a surface to be covered with the grooved tiles and/or a back surface of the tile(s);
b) arranging the grooved tiles on the surface such that at least one edge of each grooved tile is adjacent to at least one edge of one or more other grooved tiles in the assembly; and optionally,
c) placing grout in, between and/or on top of the grooved tiles.

19. The method of claim 18, wherein (i) at least one of the one or more grooves of each grooved tile intersects one or more edges of the at least one edge of the grooved tile at one or more intersection locations, and (ii) the method further comprises arranging the tiles so that the intersection locations of adjacent tiles are aligned.

20. The method of claim 18, wherein there is minimal or no space between adjacent tiles.
